(19) United States
(12) Patent Application Publication
(10) Pub. No.: US 2014/0106440 A1
(43) Pub. Date: Apr. 17, 2014

(54) ENHANCED ENZYMATIC CO2 CAPTURE TECHNIQUES ACCORDING TO SOLUTION PKA, TEMPERATURE AND/OR ENZYME CHARACTER

(71) Applicants: Nathalie J.M.C. Penders, LW Doetinchem (NL); Peter W.J. Derks, CH Bakel (NL); Geert F. Versteeg, Enschede (NL); Eric Madore, Quebec (CA); Roger Sheldon, AZ Hoog Keppel (NL); Normand Voyer, Neuville (CA); Sylvie Fradette, Pintendre (CA); Jonathan Carley, Oakville (CA); Glenn R. Kelly, Trois-Rivieres (CA)

(72) Inventors: Nathalie J.M.C. Penders, LW Doetinchem (NL); Peter W.J. Derks, CH Bakel (NL); Geert F. Versteeg, Enschede (NL); Eric Madore, Quebec (CA); Roger Sheldon, AZ Hoog Keppel (NL); Normand Voyer, Neuville (CA); Sylvie Fradette, Pintendre (CA); Jonathan Carley, Oakville (CA); Glenn R. Kelly, Trois-Rivieres (CA)

(73) Assignee: CO2 SOLUTIONS INC., Quebec (CA)

(21) Appl. No.: 14/124,066

(22) PCT Filed: Jun. 11, 2012
(86) PCT No.: PCT/CA2012/050393

§ 371 Date: Dec. 5, 2013

Related U.S. Application Data
(60) Provisional application No. 61/495,834, filed on Jun. 10, 2011.

(51) Int. Cl. B01D 53/62

(52) U.S. Cl. CPC B01D 53/62
USPC 435/266; 435/294.1

(57) ABSTRACT

Techniques related to enhancement of CO₂ absorption use selection of an enzyme coordinated with selection of an absorption solution having a pKa to enhance or maximize the CO₂ capture rate. The techniques may use various relationships between process variables such as temperature, concentration, and so on, in order to provide efficient CO₂ capture.

### FIELD OF THE INVENTION

The invention relates to the field of enzyme catalyzed CO₂ absorption and CO₂ capture.

### BACKGROUND OF THE INVENTION

Warnings from the world's scientific community combined with greater public awareness and concern over the issue of global climate change has prompted increased momentum towards global regulations aimed at reducing man-made greenhouse gas (GHGs) emissions, most notably carbon dioxide (CO₂). Ultimately, a significant cut in North American and global CO₂ emissions will require reductions from large power generation and industrial point-sources of fossil fuel-based emissions. According to the International Energy Agency's (IEA) GHG Program, as of 2008 there were approximately 8,200 such point-sources worldwide generating 14.7 billion tons of CO₂, representing nearly half of all global anthropogenic CO₂ emissions. Carbon Capture and Sequestration (CCS) provides a solution to reducing emissions from these sources.

The CCS process involves selective removals of CO₂ from a CO₂-containing flue gas, and production of a highly concentrated CO₂ gas stream which is then compressed and transported to a geologic sequestration site. This site may be a depleted oil field or a saline aquifer. Sequestration as mineral carbonates is an alternate way to sequester CO₂ that is in the development phase. Captured CO₂ can also be used for enhanced oil recovery, for injection into greenhouses, for chemical reactions and production, and for other useful applications.

Technologies for CO₂ capture from post-combustion flue gases and other gas streams are based primarily on the use of an aqueous alkanolamine based solution which is circulated through two main distinct units: an absorption tower coupled to a desorption or stripping tower.

A significant barrier to adoption of carbon capture technology on large scale is cost of capture. Conventional CO₂ capture with available technology, based primarily on the use of monoethanolamine (MEA), is an energy intensive process that involves heating the solvent to high temperature to strip the CO₂ (and regenerate the solvent) for underground sequestration. The use of MEA involves an associated capture cost of approximately US $60 per ton of CO₂ (IPCC), which represents approximately 80% of the total cost of carbon capture and sequestration (CCS), the remaining 20% being attributable to CO₂ compression, pipelining, storage and monitoring. This large cost for the capture portion has, to present, made large scale CCS unviable; based on data from the IPCC, for instance, for a 700 megawatt (MW) pulverized coal power plant that produces 4 million metric tons of CO₂ per year, the capital cost of MEA based CO₂ capture equipment on a retrofit basis would be nearly $800 million and the annual operating cost and plant energy penalty would be nearly $240 million. As such, there is a need to reduce the costs of the process and develop new and innovative approaches to the problem.

In order to help address the high costs associated with traditional CCS systems, biocatalysts have been used for CO₂ absorption applications. For example, CO₂ hydration may be catalyzed by the enzyme carbonic anhydrase or an analog thereof as follows:

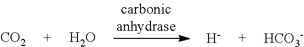

U.S. Pat. No. 7,740,689 describes a formulation and method for absorbing CO₂ from a gas using a solution containing an absorption compound and carbonic anhydrase. In addition, international PCT patent application Nos. PCT/CA2010/001212, PCT/CA2010/001213 and PCT/CA2010/001214 describe using carbonic anhydrase in combination with absorption compounds to enhance CO₂ capture.

The above patent and applications are incorporated herein by reference along with the following references: U.S. Pat. No. 6,908,507, U.S. Pat. No. 7,176,017, U.S. Pat. No. 6,524,843, U.S. Pat. No. 6,475,382, U.S. Pat. No. 6,946,288, U.S. Pat. No. 7,596,952, U.S. Pat. No. 7,514,056, U.S. Pat. No. 7,521,217, U.S. Patent Application No. 61/272,792 and U.S. Patent Application No. 61/344,869, which are all currently held by the Applicant. Various systems, reactors and processes described in the preceding references may be used in connection with various techniques described below.

### SUMMARY OF INVENTION

In one aspect, the present invention relates to a method for increasing or maximizing a capture rate of CO₂ from a CO₂-containing gas into an absorption solution, the method including:
selecting an enzyme or analog thereof for enzymatic catalysis of the hydration reaction of CO₂ into hydrogen ions and bicarbonate ions within the absorption solution; and
selecting the absorption solution having a pKa such that the absorption solution combined with the selected enzyme or analog thereof enhances kinetics of the enzymatic catalysis of the hydration reaction of CO₂.

In an optional aspect of the method, the step of selecting the absorption solution may be performed such that the pKa maximize the capture rate of CO₂ in presence of the selected enzyme or analog thereof.

In an optional aspect of the method, the overall pKa may be of at least 7, at least 7.5, at least 8.5 or at least 9.

In an optional aspect of the method, the method may include providing a concentration of the selected enzyme or analog thereof in the absorption solution in accordance with the pKa thereof.

In an optional aspect of the method, the selected enzyme may be a recombinant enzyme, a variant enzyme, a naturally occurring enzyme or any combination thereof. Optionally, the selected enzyme may be selected from archeal, bacterial or fungal source enzymes or any combination thereof. Optionally, the selected enzyme may be a carbonic anhydrase.

In an optional aspect of the method, the step of selecting the absorption solution may be performed in accordance with the following formula:

$${k}_{2}^{*} = \frac{{k}_{3}^{*} {C}_{Enzyme}}{1 + {k}_{4}^{*} {C}_{Enzyme}}$$

k₂* being a reaction rate constant of the CO₂ capture rate;
C_{Enzyme} being the concentration of the at least one enzyme; and
k₃* and k₄* being first and second reaction rate constants associated with the enzyme, wherein:

k₃*=A+B pKa;

k₄*=C+D pKa;
A, B, C and D are coefficients related to the enzyme; and
pKa is the logarithmic acid dissociation constant associated with the absorption solution.

In an optional aspect of the method, the step of coordinating may include selecting the enzyme so as to increase or maximize k₃* and reduce or minimize k₄* at the pKa of the absorption solution.

In another aspect, the present invention relates to a method for controlling a reaction rate of the reaction CO₂+H₂O←→H⁺+HCO₃⁻ in a reaction solution in presence of an enzyme or analog thereof, the method including controlling a pKa of the reaction solution as well as the concentration and type of the enzyme or analog thereof present in the reaction solution.

In an optional aspect of the method, the pKa of the reaction solution and the concentration and type of the enzyme or analog thereof may be controlled so as to maintain a generally constant k₂* in a reactor.

In an optional aspect of the method, the controlling of the pKa and the concentration and type of enzyme is performed in accordance with the following formula:

$${k}_{2}^{*} = \frac{{k}_{3}^{*} {C}_{Enzyme}}{1 + {k}_{4}^{*} {C}_{Enzyme}}$$

k₂* being a reaction rate constant of the CO₂ capture rate;
C_{Enzyme} being the concentration of the enzyme; and
k₃* and k₄* being first and second reaction rate constants associated with the type of the enzyme, wherein:

k₃*=A+B pKa;

k₄*=C+D pKa;
A, B, C and D are coefficients related to the type of the enzyme; and
pKa is the logarithmic acid dissociation constant associated with the reaction solution.

In another aspect, the present invention relates to a method for controlling a reaction rate of the hydration reaction of CO₂ into hydrogen ions and bicarbonate ions in an absorption solution in presence of an enzyme or analog thereof. The method includes controlling a pKa of the absorption solution as well as the concentration and type of the enzyme or analog thereof present in the absorption solution.

In an optional aspect of the method, the pKa of the absorption solution and the concentration and type of the enzyme or analog thereof may be controlled so as to maintain a generally constant k₂* in a reactor.

In an optional aspect of the method, the controlling of the pKa and the concentration and type of enzyme may be performed in accordance with the following formula:

$${k}_{2}^{*} = \frac{{k}_{3}^{*} {C}_{Enzyme}}{1 + {k}_{4}^{*} {C}_{Enzyme}}$$

k₂* being a reaction rate constant of the CO₂ capture rate;
C_{Enzyme} being the concentration of the enzyme; and
k₃* and k₄* being first and second reaction rate constants associated with the type of the enzyme, wherein:

k₃*=A+B pKa;

k₄*=C+D pKa;
A, B, C and D are coefficients related to the type of the enzyme; and
pKa is the logarithmic acid dissociation constant associated with the reaction solution.

In another aspect, the present invention relates to a process for absorbing CO₂ from a CO₂-containing gas at an enzymatically catalyzed CO₂ capture rate. The process includes:
coordinating a pKa of an absorption solution with an enzyme or analog thereof for enhancing or maximizing the CO₂ capture rate, the enzyme or analog thereof catalyzing the hydration reaction of CO₂ into hydrogen ions and bicarbonate ions;
providing the absorption solution having the pKa into an absorption reactor;
contacting the CO₂-containing gas with the absorption solution in presence of the enzyme or analog thereof in the absorption reactor for absorbing the CO₂ from the CO₂ containing gas at the enhanced or maximized CO₂ capture rate;
generating an ion-rich solution including the hydrogen ions and the bicarbonate ions and releasing the same from the absorption reactor; and
generating a CO₂-depleted gas stream and releasing the same from the absorption reactor.

In an optional aspect of the process, the pKa of the absorption solution may be at least 7.

In an optional aspect of the process, the pKa of the absorption solution may be at least 7.5.

In an optional aspect of the process, the pKa of the absorption solution may be at least 8.

In an optional aspect of the process, the pKa of the absorption solution may be between 9 and 10.5.

In an optional aspect of the process, the absorption reactor may have a size which is reduced according to the enhanced or maximized CO₂ capture rate.

In another aspect, the present invention relates to a use of an absorption compound for absorbing CO₂ at an enzymatically enhanced or maximized CO₂ capture rate. The absorption compound has a pKa sufficient to increase or maximize the CO₂ capture rate in presence of a selected enzyme or analog thereof.

In an optional aspect of the use, the carbonic anhydrase enzyme and the absorption solution may be coordinated in accordance with the following formula:

$${k}_{2}^{*} = \frac{{k}_{3}^{*} {C}_{Enzyme}}{1 + {k}_{4}^{*} {C}_{Enzyme}}$$

k₂* being a reaction rate constant of the CO₂ capture rate;
C_{Enzyme} being the concentration of the at least one enzyme; and
k₃* and k₄* being first and second reaction rate constants associated with the enzyme, wherein:

k₃*=A+B pKa;

k₄*=C+D pKa;
A, B, C and D are coefficients related to the enzyme; and
pKa is the logarithmic acid dissociation constant associated with the absorption solution.

In another aspect, the present invention relates to an absorption solution for absorbing CO₂ from a CO₂-containing gas. The absorption solution includes:
a selected carbonic anhydrase enzyme or analog thereof; and
a selected absorption compound, the absorption compound having a pKa coordinated with the selected enzyme for enhancing or maximizing a CO₂ capture rate into the absorption solution.

In an optional aspect of the absorption solution, the carbonic anhydrase enzyme and the absorption solution may be coordinated in accordance with the following formula:

$${k}_{2}^{*} = \frac{{k}_{3}^{*} {C}_{Enzyme}}{1 + {k}_{4}^{*} {C}_{Enzyme}}$$

k₂* being a reaction rate constant of the CO₂ capture rate;
C_{Enzyme} being the concentration of the at least one enzyme; and
k₃* and k₄* being first and second reaction rate constants associated with the enzyme, wherein:

k₃*=A+B pKa;

k₄*=C+D pKa;
A, B, C and D are coefficients related to the enzyme; and
pKa is the logarithmic acid dissociation constant associated with the absorption solution.

In another aspect, the present invention relates to a system for absorbing CO₂ from a CO₂-containing gas into an absorption solution. The system includes:
an absorption reactor for contacting the CO₂-containing gas with the absorption solution in the presence of an enzyme or analog thereof for enzymatic catalysis of the hydration reaction of CO₂ into hydrogen ions and bicarbonate ions, thereby forming a loaded absorption solution;
wherein the absorption solution includes:
   a selected carbonic anhydrase enzyme or analog thereof; and
   a selected absorption compound, the absorption compound having a pKa coordinated with the selected enzyme for enhancing or maximizing a CO₂ capture rate into the absorption solution.

In an optional aspect of the system, the carbonic anhydrase enzyme and the absorption solution may be coordinated in accordance with the following formula:

$${k}_{2}^{*} = \frac{{k}_{3}^{*} {C}_{Enzyme}}{1 + {k}_{4}^{*} {C}_{Enzyme}}$$

k₂* being a reaction rate constant of the CO₂ capture rate;
C_{Enzyme} being the concentration of the at least one enzyme; and
k₃* and k₄* being first and second reaction rate constants associated with the enzyme, wherein:

k₃*=A+B pKa;

k₄*=C+D pKa;
A, B, C and D are coefficients related to the enzyme; and
pKa is the logarithmic acid dissociation constant associated with the absorption solution.

In another aspect, the present invention relates to a process for absorbing CO₂ from a CO₂-containing gas into an absorption solution. The process includes:
providing an absorption solution including water and an absorption compound;
providing a carbonic anhydrase;
determining a first relationship between absorption kinetics and both carbonic anhydrase concentration and temperature, for the absorption solution;
determining a second relationship with between absorption kinetics and both carbonic anhydrase concentration and pKa of the absorption solution;
providing an operational carbonic anhydrase concentration, temperature and pKa of the absorption solution for absorbing the CO₂ from the CO₂-containing gas, such that the absorption kinetics enable reduced temperature and enzyme concentration and/or increased absorption rate.

In another aspect, the present invention relates to an enzyme enhanced CO₂ capture method including:
providing a solution for contacting a CO₂ containing gas to remove the CO₂ therefrom, the solution including:
   water, carbonic anhydrase or an analog thereof, and an absorption compound, the carbonic anhydrase catalyzing the hydration reaction of CO₂ to produce bicarbonate ions and hydrogen ions at a reaction rate constant k_{H2O}, the absorption compound reacting with the CO₂ and the water to produce bicarbonate ions at a reaction rate constant k′_{Am};
selecting and providing the absorption compound in a concentration such that k′_{Am} is small with respect to k_{H2O} and the absorption compound improves regenerating the carbonic anhydrase;
providing the carbonic anhydrase in a concentration to obtain an overall catalyzed CO₂ absorption rate into the water of the solution.

In an optional aspect of the method, the absorption compound may be selected and provided in a concentration such that k′_{Am} is negligible with respect to k_{H2O}.

In an optional aspect of the method, the k′_{Am} is up to 10%, up to 8%, up to 5%, up to 2%, or lower with respect to k_{H2O}.

In an optional aspect of the method, the absorption compound may include at least one tertiary alkanolamine.

In an optional aspect of the method, the at least one tertiary alkanolamine may be selected from TEA, TIPA, MDEA, DMMEA and DEMEA.

In an optional aspect of the method, the absorption compound may include at least one carbonate.

In an optional aspect of the method, the absorption compound may include at least one alkanolamine, preferably a hindered alkanolamine.

In an optional aspect of the method, the absorption compound may include at least one aminoether, preferably a hindered aminoether.

In an optional aspect of the method, the absorption compound may have a pKa of at least 7, at least 7.5, at least 8.5 or at least 9.

In an optional aspect of the method, the absorption compound may be provided in a concentration of at least 0.5 M in the solution, at least 2 M in the solution, or at least 4 M in the solution.

In an optional aspect of the method, the carbonic anhydrase may be provided in a concentration of at least 50 mg/L in the solution, at least 100 mg/L in the solution, at least 200 mg/L, or at least 400 mg/L in the solution.

In an optional aspect of the method, the carbonic anhydrase may be provided in a concentration in the solution such that the k₂* is below a plateau of k₂* versus carbonic anhydrase concentration.

In an optional aspect of the method, the method may include producing an ion-rich solution loaded with the bicarbonate ions and the hydrogen ions. The method further may include supplying the ion-rich solution to a desorption stage for releasing the bicarbonate ions and the hydrogen ions in the form of gaseous CO₂ and producing a regenerated ion-depleted solution.

In an optional aspect of the method, the method may include supplying the regenerated ion-depleted solution back as the solution for absorption of the CO₂.

In another aspect, the present invention relates to an enzyme enhanced CO₂ capture method including:
providing a solution including carbonic anhydrase or an analogue thereof and an absorption compound;
supplying the solution as a low CO₂ loaded solution to an upstream section of an absorption reactor;
flowing the solution through the absorption reactor while contacting a CO₂ containing gas with the solution, thereby increasing the CO₂ loading of the solution as the solution flows toward a downstream section of the absorption reactor and forming a high CO₂ loaded solution;
withdrawing the high CO₂ loaded solution at the downstream section of the absorption reactor; and
maintaining a carbonic anhydrase catalyzed hydration reaction of CO₂ to produce bicarbonate ions and hydrogen ions from the upstream section to the downstream section of the absorption reactor.

In an optional aspect of the method, the CO₂ loading may range depends on the characteristics of the solution, for instance the concentration and type of absorption compound(s) used therein.

In another aspect, the present invention relates to an enzyme enhanced CO₂ capture method including:
providing a solution for contacting a CO₂ containing gas to remove the CO₂ therefrom, the solution including:
   water, carbonic anhydrase or an analog thereof and an absorption compound, the carbonic anhydrase catalyzing the hydration reaction of CO₂ to produce bicarbonate ions and hydrogen ions;
selecting the absorption compound according to elevated pKa to improve regenerating the carbonic anhydrase;
providing the absorption compound in a concentration sufficient to regenerate the carbonic anhydrase while avoiding denaturing thereof;
providing the carbonic anhydrase in a concentration sufficient to dominate an overall catalyzed CO₂ absorption rate into the water of the solution.

In an optional aspect of the method, the pKa may be used as a design guide related to turnover factor in order to design, construct and/or operate an absorption reactor employing carbonic anhydrase and an absorption compound.

In an optional aspect of the method, the absorption compound may include a protonable buffer compound.

In an optional aspect of the method, the absorption compound may include at least one tertiary alkanolamine.

In an optional aspect of the method, the absorption compound may have a pKa of at least 7, at least 7.5, at least 8.5 or at least 9.

In an optional aspect of the method, the at least one tertiary alkanolamine may be selected from TEA, TIPA, MDEA, DMMEA and DEMEA.

In an optional aspect of the method, the absorption compound may be selected for its pKa and its low regeneration energy and the absorption-desorption process may be designed accordingly.

In an optional aspect of the method, the method may be further combined with aspects and/or embodiments of methods described herein.

In an optional aspect of the method, the method may include absorption-desorption design and control based on functions of carbonic anhydrase and the absorption compound.

In another aspect, the present invention relates to a method of controlling an enzyme enhanced CO₂ capture process including an absorption stage for absorbing CO₂ from a CO₂ containing gas and producing a CO₂ loaded solution and a desorption stage for receiving the CO₂ loaded solution and producing a separated CO₂ stream and an ion-lean solution for reuse in the absorption stage. The method includes:
providing a solution for contacting a CO₂ containing gas to remove the CO₂ therefrom in the absorption stage, the solution including:
   water, carbonic anhydrase or an analog thereof, and an absorption compound, the carbonic anhydrase catalyzing the hydration reaction of CO₂ into produce bicarbonate ions and hydrogen ions and produce the CO₂ loaded solution;
controlling the overall catalyzed CO₂ absorption rate into the solution by managing the concentration of the carbonic anhydrase in the solution; and
controlling regeneration of the carbonic anhydrase and improving efficiency in the desorption stage by selecting and dosing the absorption compound in the solution.

In an optional aspect of the method, the step of managing the concentration of the carbonic anhydrase in the solution may be performed to control the catalyzed CO₂ hydration rate into the water of the solution.

In an optional aspect of the method, the absorption compound may include a protonable buffer compound.

In an optional aspect of the method, the absorption compound may include at least one tertiary alkanolamine.

In an optional aspect of the method, the absorption compound may includes at least one of TEA, TIPA, MDEA, DMMEA and DEMEA.

In another aspect, there is provided a method of controlling an enzyme enhanced CO₂ capture process. The method includes:
providing a solution for contacting a CO₂ containing gas to remove the CO₂ therefrom, the solution including:
   water, carbonic anhydrase or an analog thereof, and an absorption compound, the carbonic anhydrase catalyzing the hydration reaction of CO₂ into produce bicarbonate ions and hydrogen ions and produce a CO₂ loaded solution;
controlling the overall catalyzed CO₂ absorption rate into the solution by managing the concentration of the carbonic anhydrase in the solution; and
controlling the CO₂ capacity of the solution by selecting and dosing the absorption compound in the solution.

In an optional aspect of the method, the step of managing the concentration of the carbonic anhydrase in the solution may be performed to control the catalyzed CO₂ hydration rate into the water of the solution.

In an optional aspect of the method, the absorption compound may include a protonable buffer compound.

In an optional aspect of the method, the absorption compound may include at least one tertiary alkanolamine, hindered alkanolamine and/or hindered aminoether.

In an optional aspect of the method, the at least one tertiary alkanolamine may be selected from TEA, TIPA, MDEA, DMMEA and DEMEA.

In an optional aspect of the method, the CO₂ capacity of the solution may be increased to reduce the overall volume of the solution required.

While the invention will be described in conjunction with example embodiments, it will be understood that it is not intended to limit the scope of the invention to such embodiments.

On the contrary, it is intended to cover all alternatives, modifications and equivalents as may be included in the present description and the appended claims.

It should be understood that any one of the above mentioned optional aspects of each process, method, use and absorption solution may be combined with any other of the aspects thereof, unless two aspects clearly cannot be combined due to their mutually exclusivity. For example, the various operational steps and/or structural elements of the process described herein-above, herein-below and/or in the appended Figures, may be combined with any of the general method or use descriptions appearing herein and/or in accordance with the appended claims.

### BRIEF DESCRIPTION OF THE DRAWINGS

Embodiments, examples and illustrations of some of the techniques described herein will be further understood in light of the following figures.

FIG. 1 is a process flow diagram of a CO₂ capture process including absorption and desorption units according to an optional embodiment of the present invention.

FIG. 2 is a graph of an absorption reaction rate constant k₂* versus a concentration of an enzyme 5X CA at 298 K in an absorption solution of MDEA according to an optional embodiment of the present invention.

FIG. 3 is a graph of an absorption reaction rate constant k₃* versus a pKa of an absorption solution according to an optional embodiment of the present invention.

FIG. 4 is a graph of an absorption reaction rate constant k₄* versus a pKa of an absorption solution according to an optional embodiment of the present invention.

FIG. 5 is a graph of an experimental absorption reaction rate constant k₂* versus a calculated absorption reaction rate constant k₂* according to an optional embodiment of the present invention.

FIG. 6 is a graph of an absorption reaction rate constant k₃* versus a pKa of an absorption solution according to an optional embodiment of the present invention.

FIG. 7 is a graph of an absorption reaction rate constant k₄* versus a pKa of an absorption solution according to an optional embodiment of the present invention.

FIG. 8 is a schematic illustration of the reaction mechanism of catalytic CO₂ absorption by an absorption compound in presence of an enzyme.

FIG. 9 is a schematic drawing of an experimental absorption test set-up.

FIG. 10 is a conceptual schematic of k₂* versus enzyme concentration comparing different enzymes.

FIG. 11 is a graph showing results of experiments performed at 298 K.

FIG. 12 is a graph showing results of experiments performed at 313 K.

FIG. 13 is a graph showing results of experiments performed at 333 K.

FIG. 14 is a graph showing rate constant k₃* as function of the temperature according to an optional embodiment of the present invention.

FIG. 15 is a graph showing rate constant k₄* as function of the temperature according to an optional embodiment of the present invention.

FIG. 16 is a graph showing a parity plot for enzymatic rate constant k_{H2O}*, where the dashed lines indicate 20% error ranges.

FIG. 17 is a graph of relative kₒᵥ versus initial CO₂ loading in enzyme and 2M MDEA solutions.

FIG. 18 is a graph of relative kₒᵥ versus initial CO₂ loading in an enzyme and 4M MDEA solution.

FIG. 19 is a graph of the overall kinetic rate constant as a function of enzyme concentration in a 1.0 kmol/m³ TEA solution at 298 K.

FIG. 20 is a graph of the overall kinetic rate constant as a function of enzyme concentration in a 2.0 kmol/m³ TEA solution at 298 K.

FIG. 21 is a graph of the overall kinetic rate constant as a function of enzyme concentration in a 4.0 kmol/m³ TEA solution at 298 K.

FIG. 22 is a graph of the overall kinetic rate constant as a function of enzyme concentration in 1.0, 2.0 and 4.0 kmol/m³ TEA solution at 298 K.

FIG. 23 is a graph of the overall kinetic rate constant as a function of enzyme concentration in a 1.0 kmol/m³ DMMEA solution at 298 K.

FIG. 24 is a graph of the overall kinetic rate constant as a function of enzyme concentration in a 2.0 kmol/m³ DMMEA solution at 298 K.

FIG. 25 is a graph of the overall kinetic rate constant as a function of enzyme concentration in DMMEA solutions of 1.0 and 2.0 kmol/m³ at 298 K.

FIG. 26 is a graph of the overall kinetic rate constant as a function of enzyme concentration in a 0.5 kmol/m³ DEMEA solution at 298 K.

FIG. 27 is a graph of the overall kinetic rate constant as a function of enzyme concentration in a 1.0 kmol/m³ DEMEA solution at 298 K.

FIG. 28 is a graph of the overall kinetic rate constant as a function of enzyme concentration in a 2.0 kmol/m³ DEMEA solution at 298 K.

FIG. 29 is a graph of the overall kinetic rate constant as a function of enzyme concentration in DEMEA solutions of 0.5, 1.0 and 2.0 kmol/m³ at 298 K.

FIG. 30 is a graph of the overall kinetic rate constant as a function of enzyme concentration in a 1.0 kmol/m³ TIPA solution at 298 K.

FIG. 31 is a graph of the overall kinetic rate constant as a function of enzyme concentration in a 2.0 kmol/m³ TIPA solution at 298 K.

FIG. 32 is a graph of the overall kinetic rate constant as a function of enzyme concentration in TIPA solutions of 1.0 and 2.0 kmol/m³ at 298 K.

FIG. 33 is a graph of kₒᵥ versus enzyme concentration for different concentrations of AMP.

FIG. 34 is a graph of kₒᵥ versus 1/T for different concentrations of enzyme.

FIG. 35 is a graph of the overall reaction rate constant as function of the MDEA concentration in combination with 250 g/m³ hCA II at 298 K.

FIG. 36 is a graph of relative kₒᵥ in 1.45 M K₂CO₃ for CO₂ loading ranging from 0 to 0.2 at 298 K.

FIG. 37 is a graph of CO₂ pressure decrease rate in 0.5 M Na₂CO₃ for CO₂ loadings of 0, 0.2 & 0.5 and enzyme concentrations of 0, 0.1 and 1 g/L.

FIG. 38 is a process flow diagram of an absorption-desorption process with temperature control for thermo-morphic carbonic anhydrase embodiments.

FIG. 39 is a graph showing physical solubility of N₂O in 2 kmol·m⁻³ MDEA with varying enzyme concentration at 298 K.

FIG. 40 is a graph showing k₂* as function of the 5X CA mutant concentration in combination with 2 kmol·m⁻³ MDEA at 298 K.

FIG. 41 is a graph showing k₂* as function of the MDEA concentration in combination with 5X CA at 298 K.

### DETAILED DESCRIPTION

The present invention provides techniques for removing CO₂ from a gas by contacting the gas with an absorption solution in the presence of an enzyme or an analog thereof. In some implementations, the absorption solution may contain one or more absorption compounds and the enzyme may include carbonic anhydrase. As will be explained further below, a variety of different types of carbonic anhydrase may be used and with various delivery techniques.

Relationships Between Enzyme, Solution pKa, Temperature, Reaction Kinetics

Working extensively with different types of carbonic anhydrase, it has been found that each carbonic anhydrase can have its own character with regard to the kinetics of catalyzing the hydration reaction of CO₂ into hydrogen and bicarbonate ions. While carbonic anhydrases from various different sources and of various different characters provide enzymatic catalysis for enhanced CO₂ capture, the variability between different carbonic anhydrase types can involve some challenges for the design and operation of CO₂ capture systems. In addition, this variability between carbonic anhydrases can increase the dependency of a given CO₂ capture system on a given enzyme type or enzyme production so that the CO₂ capture system continues to function as desired under its designed operating conditions.

However, it has been found that in a CO₂ capture system with an absorption solution, there is a relationship between the kinetics of the CO₂ absorption, the carbonic anhydrase and the pKa (acid dissociation constant) of the absorption solution. The relationship as well as its discovery and derivation will be further described below. Pursuant to these findings, it is possible to design and/or operate a CO₂ capture system that uses an absorption solution and an enzyme such as carbonic anhydrase, by coordinating the character of the enzyme with the pKa of the absorption solution, in order to enhance, maximize or control the CO₂ capture kinetics.

In one instance, for example, the relationship may be summarized by the following equation:

$${k}_{2}^{*} = \frac{{k}_{3}^{*} {C}_{Enzyme}}{1 + {k}_{4}^{*} {C}_{Enzyme}}$$

k₂* being a reaction rate constant of the CO₂ capture rate;
C_{Enzyme} being the concentration of the enzyme; and
k₃* and k₄* being first and second reaction rate constants associated with the type of the enzyme.

k₃* and k₄* may be correlated with pKa of an absorption compound as follows:

k₃*=A+B pKa;

and

k₄*=C+D pKa;
wherein A, B, C and D are coefficients related to the type of the enzyme; and pKa is the logarithmic acid dissociation constant associated with the solution.

In addition, k₃* and k₄* may be correlated with temperature of an absorption system as follows:

k₃*(T)=E×exp(F/T);

and

k₄*(T)=G×exp(H/T);
wherein E, F, G and H are coefficients related to the type of enzyme, and T is the temperature of the system.

Using temperature and pKa correlations, an absorption system may be designed or operated to achieve a desired range of absorption kinetics while utilizing an efficient concentration and type of carbonic anhydrase.

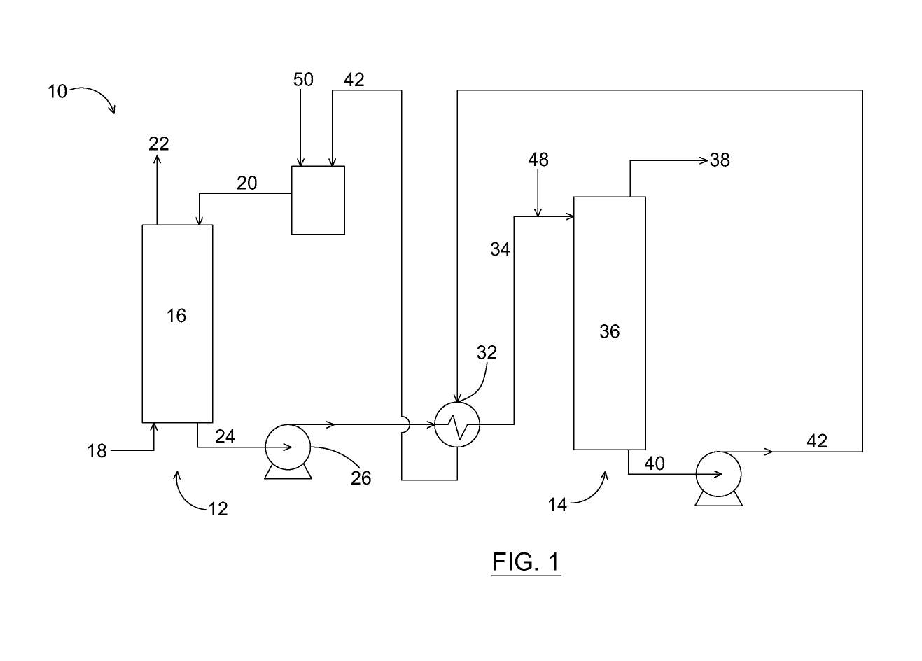

In some implementations, the relationship between pKa and the enzyme may be used to design or operate a CO₂ capture process, such as the one illustrated in FIG. 1. More regarding the relationship between the kinetics of the CO₂ absorption, the carbonic anhydrase and the pKa and composition of the absorption solution, will be discussed further below.

Referring to FIG. 1, an overall CO₂ capture process 10 is shown and includes an absorption unit 12 and a desorption unit 14. The absorption unit 12 may include an absorber reactor 16 which receives a CO₂-containing gas 18 that can come from a variety of sources. In one aspect, the CO₂-containing gas 18 is an effluent gas such as power plant flue gas, industrial exhaust gas, aluminum refining flue gas, aluminum smelting off-gas, steel production flue gas, chemical production flue gas, combustion gas from in-situ oil sands production etc. In another optional aspect, the CO₂-containing gas 18 includes or is a process gas stream such as raw or semi-processed natural gas, a hydrocarbon cracked gas (such as in ethylene production) or a carbon monoxide catalytic shift gas (such as in ammonia production). In another optional aspect, the CO₂-containing gas 18 is a naturally occurring gas such as ambient air. The absorber reactor 16 also receives an absorption solution 20 (which may also be referred to as a “CO₂-lean solution” herein). In the absorber reactor 16, the conversion of CO₂ into bicarbonate and hydrogen ions takes place in the presence of carbonic anhydrase or an analog thereof, thereby producing a CO₂-depleted gas 22 and an ion-rich solution 24. Preferably, the absorber reactor 16 is a direct-contact type reactor, such as a packed tower or spray scrubber or otherwise, allowing the gas and liquid phases to contact and mix together. The ion-rich solution 24 may be pumped by a pump 26 to downstream parts of the process, such as heat exchangers, desorption units, regeneration towers and the like. Part of the ion-rich solution 24 may be recycled back to the absorber reactor 16 via an ion-rich solution return line, which can improve mixing of the bottoms of the absorber reactor to avoid accumulation of precipitates and reactor deadzones, as the case may be. The absorber 16 may also have other recycle or return lines, as desired, depending on operating conditions and reactor design.

In one optional scenario, the ion-rich solution 24 may be further processed, used or valorized, for example by reacting or contacting waste streams containing cations such as sodium, calcium and/or magnesium in order to precipitate a solid carbonate. The waste stream may be industrial wastes such as bauxite residue from aluminum refining, steel slag, related and/or other waste streams or mineral sources. The ion rich solution 24 may also be reutilized and/or combined with cations as a bicarbonate solid or slurry for such purposes as enhanced algae or other microbial farming. In this sense, the process may be a “once-through” absorption process whereby the ion-rich solution generated in the absorption process is not subjected to desorption to separate the CO₂ gas but is rather used directly to utilize the ions therein to produce, for example, a neutralized mineral product.

In another optional scenario, as shown in FIG. 1, the ion-rich solution 24 may then be fed to the desorption unit 14, in which it can be regenerated and a CO₂ gas can be separated for sequestration, storage or various uses. The ion-rich solution 24 is preferably heated, which may be done by one or more heat exchanger 32, to favor the desorption process. The heat exchanger may use heat contained in one or more downstream process streams in order to heat the ion-rich solution, e.g. ion-depleted solution 42. The heated ion-rich solution 34 is fed into a desorption reactor 36. In the desorption unit, carbonic anhydrase or analogs thereof may be present within the ion-rich solution 34, allowing the carbonic anhydrase to flow with the ion-rich solution 34 while promoting the conversion of the bicarbonate ions into CO₂ gas 38 and generating an ion-depleted solution 40. The carbonic anhydrase could also be fixed or immobilized within reactors or particles passing within and/or through the reactors. Alternatively, the enzymes could also be removed from the ion-rich stream prior to feeding it to the desorption reactor 36. The process also includes releasing the CO₂ gas 38 and the ion-depleted solution 40 from the desorption unit 14 and, preferably, sending a recycled ion-depleted solution 42 to make up at least part of the absorption solution 20. The ion-depleted solution 42 is preferably cooled prior to re-injection into the absorption unit, which may be done by the heat exchanger 32. The desorption reactor 36 may also include various recycle or return streams (not illustrated) as desired. The desorption unit 14 may also include one or more reboilers each of which takes a fraction of the liquid flowing through a corresponding one of the desorption reactors and heats it to generate steam that will create a driving force such that CO₂ will be further released from the solution. In some embodiments of the process, absorption is performed around 0° C.-80° C., preferably 40° C.-70° C., an d desorption around 60° C.-180° C., preferably 70° C.-150° C. Optionally, absorption may b e performed between 15 and 35° C. to favor enzymatic activity. In order to provide the carbonic anhydrase to the ion-rich solution 34 entering the desorption reactor 36, there may be an enzyme feed stream 48 prior to the inlet into the desorption reactor 36.

It should be noted that the carbonic anhydrase may be provided in a number of other ways. For instance, carbonic anhydrase may be provided to the absorption solution 20 which flows through the absorber reactor 16 and is not removed from the ion-rich solution 34 which is fed to the desorption reactor 36. In this scenario, the carbonic anhydrase is introduced into the overall CO₂ capture process 10 via an absorption solution make-up stream 50, which is preferably mixed with the recycled ion-depleted solution 42. According to another optional aspect, the carbonic anhydrase may be added to the absorption or desorption units via multiple enzyme feed streams. Depending on operating conditions and the thermal stability of the carbonic anhydrase strain, fraction, variant or analog that is used in the process, the carbonic anhydrase may be introduced at a given point in the process and spent enzyme may be replaced at a given point in the process. For example, when free enzyme is used as a component of the absorption solution, the process may include periodic or continuous removal of denatured enzyme or reduced-activity enzyme, which may be done as part of an absorption solution reclaiming or make-up technique. It should also be mentioned that one or more of multiple absorption and desorption reactors may have enzyme flowing there-through, depending for example on the temperature within each reactor, so as to maximize enzyme activity and minimize enzyme denaturing. The enzyme may alternatively be allowed to flow through the entire system to flow through each one of the desorption reactors.

Carbonic anhydrase is a very efficient catalyst that enhances the reversible reaction of CO₂ to HCO₃⁻. Carbonic anhydrase is not just a single enzyme form, but a broad group of metalloproteins that exists in three genetically unrelated families of isoforms, α, β and γ. Carbonic anhydrase (CA) is present in and may be derived from animals, plants, algae, bacteria, etc. The human variant CA II, located in red blood cells, is the most studied and has a high catalytic turnover number. The carbonic anhydrase includes any analogue, fraction and variant thereof and may be alpha, gamma or beta type from human, bacterial, fungal or other organism origins, having thermostable or other stability properties, as long as the carbonic anhydrase can be provided to function in the CO₂ capture or desorption processes to enzymatically catalyse the reaction:

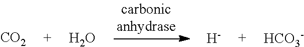

One of the ways carbonic anhydrase enhances performance of CO₂ capture solutions in the desorption unit is by reacting with dissolved bicarbonate ions and maintaining a maximum CO₂ concentration gradient between gas and liquid phases to improve CO₂ transfer rate from the liquid solution phase to the gas phase. Referring to FIG. 1, when the incoming ion-rich solution 34 also includes carbonate/bicarbonate precipitates, which are solids that make the ion-rich solution 34 a slurry-like consistency, the carbonic anhydrase flowing with the ion-rich solution 34 is able to enhance performance in the desorption unit by reacting with dissolved bicarbonate ions and maintaining a maximum bicarbonate ion concentration gradient between solid and liquid phases to improve carbonate/bicarbonate transfer rate from the solid phase into the liquid solution phase. In some cases, the ion-rich solution 24 exiting the absorption unit may be treated by removing excess liquid and thus pre-concentrating the solids prior to the desorption unit, and the removed liquid stream (not illustrated) can be recycled back into the process, e.g. back into stream 42.

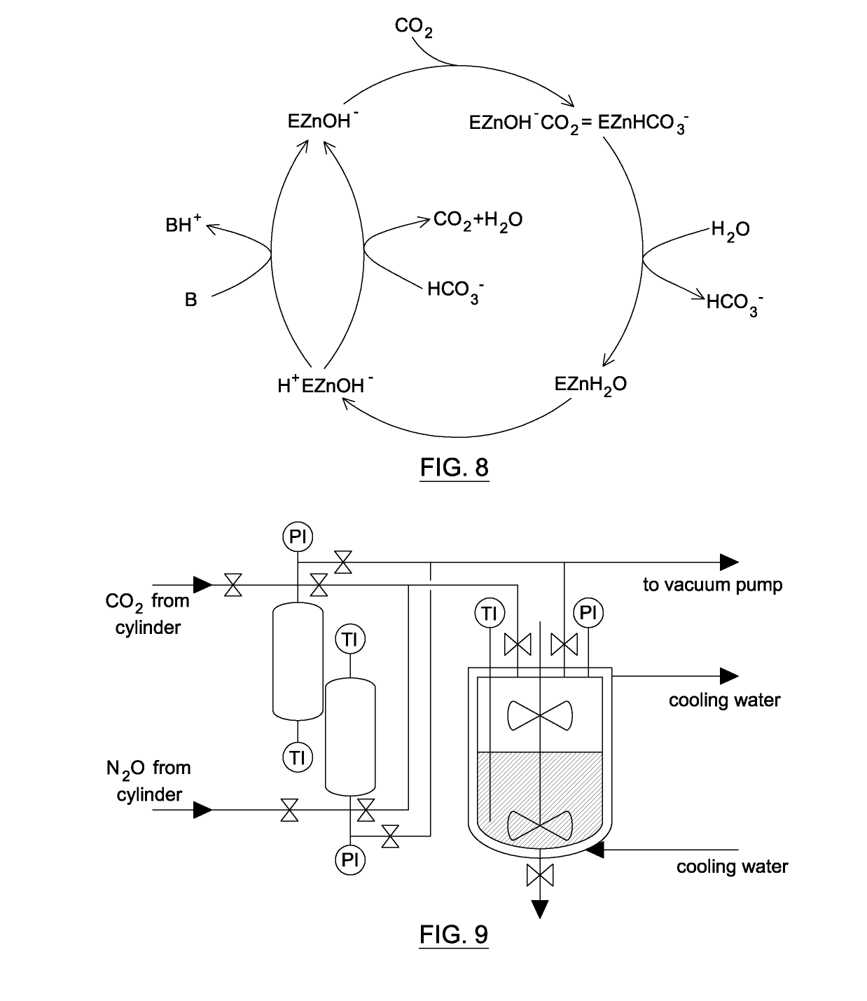

During enzyme catalyzed carbon dioxide absorption into absorption solutions, several reactions occur and may be summarized in the “wheel of reaction” represented in FIG. 8.

Referring to FIG. 8, for the catalysed reaction of CO₂ hydration, a proposed mechanism for CA above pH 7 is that the dominant reaction mechanism of carbonic anhydrase with CO₂ can be described with the following:

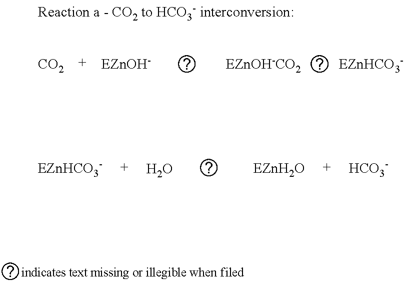

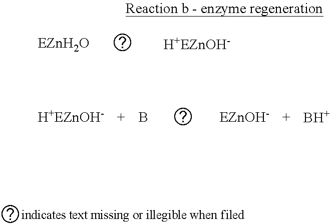

At low buffer concentrations (<10 mM), the intermolecular proton transfer, i.e. the second step of Reaction b, is rate limiting, while at high buffer concentration, the intra molecular proton transfer, i.e. the first step of Reaction b, is rate limiting. Since water is a very weak base and therefore a poor proton acceptor and OH⁻ is not abundant at the pH at which the enzyme functions best, a dilute buffer solution is preferably used as proton acceptor in kinetic experiments. In some aspects of the present invention, the dilute buffer solution (millimolar range) is replaced by a more concentrated alkanolamine solution with concentrations that may be, in some aspects and example, up to about 4 M and a corresponding pH range of about 11 to about 11.6. It should be noted that in other aspects, the concentrations may be up to 10 M, for example, depending on the particular compound being used. For instance, in one aspect, the concentration is up to a concentration such that the increased viscosity of the resulting solution does not have a too negative effect on the process at the given process conditions.

The article by F. Larachi. “Kinetic model for the reversible hydration of carbon dioxide catalyzed by human carbonic anhydrase II”. Ind. Eng. Chem. Res., 49(19):9095-9104, 2010 (hereinafter referred to as “Larachi”) showed that CO₂ hydration by hCA II is best described by a random pseudo quad quad iso ping pong catalytic (1-transitory complex) mechanism. In that mechanism, the first transitory complex (EZnOH⁻CO₂ [symbol] EZnHCO₃⁻) is left out of consideration and the intermolecular H⁺ transport (2nd part of Reaction b) is extended with an additional parallel reaction:

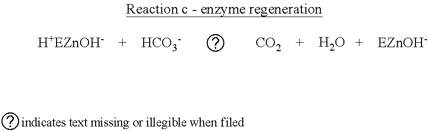

This mechanism results in a very complex and long kinetic rate expression and therefore Larachi is referred to and incorporated herein by reference.

Reactive absorption of CO₂ from process gas streams has been an important part of many industrial processes. The conventional technology to capture CO₂ on a large scale is an absorption-desorption process, in which aqueous solutions of alkanolamines (also referred to in industry as “amines”) are frequently used as solvents. Different alkanolamines can be used including primary, secondary or tertiary alkanolamines. The reaction mechanisms between primary/secondary and tertiary amines with CO₂ are different. The reaction between CO₂ and primary/secondary amines is significantly faster than the reaction between CO₂ and tertiary amines. As a result of the faster reaction, the absorption column has smaller dimensions when primary/secondary amines are used. However, an advantage of tertiary amines is that the regeneration energy is significantly lower than the regeneration energy of primary and secondary amines. As a result of the lower regeneration energy of tertiary amines, the processing costs for stripping may be lower.

It would be advantageous to have a combination of both fast absorption and low regeneration energy. In one aspect, one may use carbonic anhydrase enhanced absorption with a low desorption energy compound, such as tertiary amines and carbonate based solutions, which facilitate lower energy requirements for desorption and lower temperatures, which can also reduce or avoid denaturing of the carbonic anhydrase and enable use of a smaller desorption tower. In another aspect, one may use a fast absorption compound, such as primary and/or secondary amines for enhanced absorption, with carbonic anhydrase enhanced desorption to lower the energy requirements for the primary/secondary amine solution regeneration.

In another aspect, the enzyme carbonic anhydrase is provided to flow with the solution throughout the process, to not only accelerate the transformation of CO₂ to HCO₃⁻, but also the reverse reaction, which is of major importance during the regeneration of the CO₂ loaded solution (also referred to as the “carbonate loaded solution” or the “ion-rich solution” herein).

Regarding kinetics and reaction mechanisms, when CO₂ is absorbed for example in an alkanolamine absorption solution, the following reactions occur simultaneously:

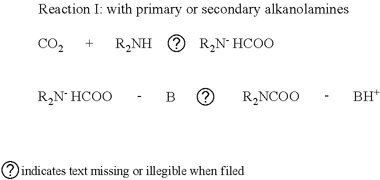

The corresponding reaction rate may be formulated as follows:

H_{CO}_{₂}=k [symbol] C [symbol] C_{CO}_{₂}

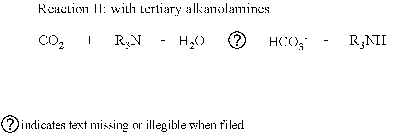

The corresponding reaction rate may be formulated as follows:

R_{CO}_{₂}=k_{OH}C_{OH}C_{CO}_{₂}

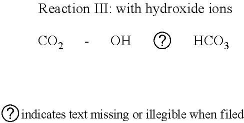

The corresponding reaction rate may be formulated as follows:

R_{CO}_{₂}=k_{H}_{₂}_{O}C_{CO}_{₂}

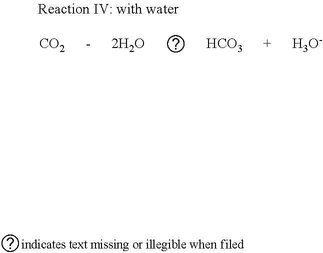

The corresponding reaction rate may be formulated as follows:

R_{CO}_{₂}=k_{H}_{₂}_{O}C_{CO}_{₂}

The overall forward reaction rate constant, k_{OV}, is determined by the contributions of each of these four reactions, whose kinetic rate expression is usually given as follows:

k_{OV}=k [symbol] C [symbol] −k_{OH}C [symbol] +H_{H}_{₂}_{O}

k_{OV}=k′_{Am}+k′_{OH}+k′_{H}_{₂}_{O}

The forward reaction rate constants of the four reactions I, II, III and IV as reported in literature are listed in the following table.

TABLE 1
Forward kinetic rate constants in a 2 kmol/m³ MDEA solution at 298 K

| | | |
|---|---|---|
| | 2nd order | 1st order |
| | rate constant | rate constant |
| Reaction | [m³mol⁻¹s⁻¹] | [s⁻¹] |

| | | | | |
|---|---|---|---|---|
| CO₂ + MDEA | k_{Am} | 0.0052 | k_{Am}′ | 10.4 |
| | | 0.0070 | | 14.0 |
| CO₂ + OH⁻ | k_{OH} | 8.35 | k_{OH}′ | 23.8 |
| CO₂ + H₂O | | | k_{H}₂O′ | 0.026 |

Table 1 illustrates that in a 2 kmol·m⁻³ MDEA solution the contribution of Reaction IV can be neglected based on the reaction rate constant. The pH of a lean 2 kmol/m³ MDEA solution is approximately 11.4, giving a hydroxide ion concentration of 0.00286 kmol/m³; however as soon as the solution is slightly loaded the hydroxide ion concentration quickly decreases. Therefore, after initial loading, the contribution of Reaction III can also be neglected. As a result the overall forward reaction rate for the absorption of CO₂ into an aqueous tertiary alkanolamine solution is fully determined by the rate of Reaction I and/or II, and therefore k_{OV}≈k′_{Am}.

The absorption solution includes at least one absorption compound which may serve as base. Optionally, the base may also be bicarbonate ions HCO₃⁻ formed in the different reactions of the overall absorption reaction mechanism (FIG. 8).

Experiments on the mechanism of enzyme catalyzed carbon dioxide absorption into absorption solutions have shown that it is the overall hydration reaction of CO₂ into bicarbonate ions and hydrogen ions which is catalyzed in presence of an enzyme.

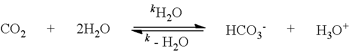

The overall absorption reaction rate therefore strongly depends on the hydration reaction rate. The latter may even be considered as the overall absorption reaction rate. The overall reaction rate may be reduced to:

$${k}_{2}^{*} = \frac{{k}_{OV} - {k}_{Am} {C}_{Am}}{{C}_{{H}_{2} O}}$$

In aqueous (e.g. sodium) carbonate systems, carbon dioxide can react with:

1. hydroxide (Pinsent et. al., 1956; Pohorecki and Moniuk, 1988)

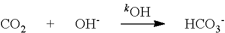

with following overall forward reaction rate:

R_{CO2}=k_{OH}·C_{OH}·C_{CO2}=k′_{OH}·C_{CO2}

2. water (Pinsent et. al., 1956; Kern, 1960)

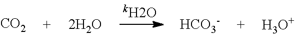

with following overall forward reaction rate:

R_{CO2}=k_{H2O}·C_{H2O}^{x}·C_{CO2}=k′_{H2O}·C_{CO2}

Regarding mass transfer considerations, the absorption of a gas A into a liquid is generally described by the following equation:

$${J}_{A} = \frac{{C}_{A , G} - {C}_{A , L} / {m}_{A}}{1 / {k}_{G} + 1 / {mk}_{L} {E}_{A}}$$

For a system consisting of a pure gas and assuming ideal gas behaviour and a freshly prepared and therefore lean liquid (C_{A,L}=0), the above equation can be simplified to:

$${J}_{A} = {m}_{A} {k}_{L} {E}_{A} \frac{{P}_{A}}{RT}$$

The chemical enhancement factor, E_{A}, is a function of the so-called Hatta number. When the absorption occurs in the first order regime and Ha>2, the enhancement factor equals the Hatta number:

$${E}_{A} = Ha = \frac{\sqrt{{k}_{1} {D}_{A}}}{{K}_{L}}$$

For reactions different from the simple first-order reaction, the process can be considered in the pseudo first order regime when next criterion is fulfilled:

2<Ha<<E_{inf}

where E_{inf} is the infinite enhancement factor. For irreversible reactions, the infinite enhancement factor is defined as follows:

$${E}_{inf} = 1 + \frac{{D}_{Am}}{{D}_{A}} \frac{{C}_{Am}}{{v}_{AM}} \frac{RT}{{m}_{A} {P}_{A}}$$

In further optional aspects of the process, the ion-rich solution may contain from about 0.1 M to 10 M of bicarbonate ions. The carbonate loading of the solution will depend on the operating conditions, reactor design and the chemical compounds that are added. For instance, when potassium or sodium bicarbonate compounds are used in the absorption solution, the ion-rich solution may contain from about 0.2 M to 1.5 M of bicarbonate ions and when other compounds such as tertiary amines are used the ion-rich solution may contain from about 1 M to 10 M of bicarbonate ions. When the ion-rich solution is highly loaded with carbonate/bicarbonate ions, it may become much more viscous which can have a detrimental effect of mass transport within the solution. The presence of carbonic anhydrase flowing with the solution further enhances the mass transport along with the enzymatic reaction, thus improving the desorption unit and overall CO₂ capture and regeneration process, for instance by supersaturating the solution with bubbles of gaseous CO₂. In addition, temperatures in the desorption unit may range between about 60° C. and about 150° C., for example.

In one aspect of the present invention, it has been found that by using an absorption compound, such as a tertiary alkanolamine like MDEA, in combination with carbonic anhydrase, at certain conditions and parameters, the concentration of the absorption compound does not materially affect the absorption rate while the carbonic anhydrase significantly enhances the absorption of CO₂ in aqueous solution. Therefore, the enzyme does not enhance the reaction of CO₂ with the absorption compound, since the rate of this reaction is a function of the absorption compound concentration. Rather, the enzyme enhances the reaction of CO₂ with water in the aqueous solution. In the presence of enzyme, this reaction is not only first order in CO₂, but also first order in water. Thus, carbonic anhydrase may provide a solution for the efficient capture of CO₂ from flue gases by significantly increasing the kinetics of its absorption into an aqueous solution containing a compound such as MDEA, a tertiary amine, which enables increased absorption capacity of bicarbonate and hydrogen ions and also requires relatively low regeneration energy for downstream desorption for example.

Various absorption experiments, calculations and derivations were performed, some of which will be described below, and relationships between variables of the CO₂ capture system have been found.

Absorption experiments were performed in a thermostated stirred cell type reactor operated with a smooth and horizontal gas-liquid interface. The reactor was connected to two gas supply vessels filled with carbon dioxide (99.9%, Hoekloos) or nitrous oxide (>99%, Hoekloos) from gas cylinders. Both the reactor and gas supply vessels were equipped with digital pressure transducers and PT-100 thermocouples. The measured signals were recorded in a computer. The pressure transducer connected to the stirred cell was a Druck PTX-520 pressure transducer (range 0-2 bars) and the gas supply vessels were equipped with Druck PTX-520 pressure transducers (range 0-100 bars). A schematic drawing of the experimental set-up is shown in FIG. 9.

In a typical experiment, an amine (e.g. MDEA) solution with desired concentration was prepared by dissolving a known amount of MDEA (99%, Aldrich) in a known amount of water together with a known amount of enzyme solution (human carbonic anhydrase (hCA II) or a thermostable variant of hCA II (‘5X’mutant, CO2 Solutions Inc.). Approximately 500 ml of the solution was transferred to the reactor, where inerts were removed by applying vacuum for a short time. Next, the solution was allowed to equilibrate at 298 K before its vapour pressure (Pᵥₐₚ) was recorded.

Regarding physical absorption, a predefined amount of N₂O was fed to the reactor from the gas bomb. The stirrer in the reactor was switched on, while a flat gas-liquid interface was maintained in the reactor. The stirrer speed was adjusted to 100 rpm. The absorption rate was studied by measuring the pressure decrease as a function of time. After a certain time the stirrer speed was increased to approximately 1000 rpm to reach the equilibrium pressure (P_{eq}) in the gas phase. The final temperature and pressure in the gas supply bomb was noted. From the initial and final conditions (T and P) in the gas supply system, the amount of gas added to the reactor was calculated. A mass balance over the gas and liquid phase for N₂O in combination with an above equation yields the following:

$$\frac{d ln ( P - {P}_{eq} )}{d t} = \frac{{k}_{L} {A}_{CL} ( {m}_{{N}_{2} O} {V}_{L} + {V}_{C} )}{{V}_{L} {V}_{O}}$$

The N₂O partial pressure in the reactor was calculated by subtracting the lean liquid's vapour pressure, determined explicitly at the beginning of the experiment, from the recorded total pressure in the reactor. The liquid side mass transfer coefficient, k_{L}, is determined from the straight line with a constant slope yielded by plotting the In-term on the left hand of the previous equation versus time. The distribution coefficient of N₂O in aqueous MDEA can be calculated from the same experiment by the following:

$${m}_{{N}_{2} O} = {( \frac{{C}_{{N}_{2} O , L}}{{C}_{{N}_{2} O , C}} )}_{eq} = \frac{{P}_{0} - {P}_{eq}}{{P}_{eq} - {P}_{vap}} \frac{{V}_{C}}{{V}_{L}}$$

Regarding reactive absorption, the method for the reactive absorption is analogous to the method for physical absorption, only now the gas is CO₂ instead of N₂O. A mass balance over the gas phase for CO₂ in combination with some of the above equations yields the following:

$$\frac{d ln {P}_{{CO}_{2}}}{d t} = \frac{\sqrt{{k}_{OV} {D}_{{CO}_{2}}} {A}_{CL} {m}_{{CO}_{2}}}{{V}_{C}}$$

The CO₂ partial pressure in the reactor was calculated by subtracting the lean liquid's vapour pressure from the recorded total pressure in the reactor. Typically, a plot of the natural logarithm of the carbon dioxide partial pressure versus time will yield a straight line with a constant slope, from which the overall kinetic rate constant, k_{OV}, can be determined, once the required physico-chemical constants are known. The diffusion coefficient of carbon dioxide in the solution is calculated with the N₂O analogy from the diffusion coefficient of N₂O in the solution and the diffusion coefficients of CO₂ and N₂O in water were calculated using the correlations given in the A. Jamal. “Absorption and Desorption of CO₂ and CO in Alkanolamine Systems” PhD thesis, The University of British Colombia, Canada, 2002 (hereinafter referred to as “Jamal”).

$${D}_{{CO}_{2} , Am} = {D}_{{CO}_{2} , water} \frac{{D}_{{N}_{2} O , Am}}{{D}_{{N}_{2} O , water}}$$

The distribution coefficient of carbon dioxide is estimated using the N₂O analogy:

$${m}_{{CO}_{2} , Am} = {m}_{{CO}_{2} , water} \frac{{m}_{{N}_{2} O , Am}}{{m}_{{N}_{2} O , water}}$$

The distribution coefficients of CO₂ and N₂O in water were calculated using the correlations given by Jamal. The physical solubility of N₂O in aqueous MDEA was experimentally determined for experimental conditions relevant for the present study as described above.

To determine the influence of carbonic anhydrase on the physical solubility of nitrous oxide in aqueous MDEA solutions, measurements with and without carbonic anhydrase were performed. Two series of experiments were carried out at 298 K, MDEA concentration of 2 kmol/m³ and enzyme concentrations ranging from 0 to 1000 g/m³ for freshly prepared solutions and solutions with a CO₂-loading of 1%. From the experimental data, it can be concluded that, within the experimental accuracy, the physical solubility of nitrous oxide is not influenced by the presence of carbonic anhydrase. The obtained distribution coefficient is well in line with data found in literature.

Regarding liquid side mass transfer coefficient (k_{L}), it is determined for the same set of experiments. The experimental data show that for a fresh aqueous MDEA solution the enzyme concentration has some influence on k_{L}; initially k_{L} decreases and then increases with increasing enzyme concentration. However, as soon as the solution is slightly pre-loaded with CO₂ (1%<α<5%) the presence of enzyme has no influence on k_{L}.

In order to further validate the obtained overall reaction rate constants from experiments without enzyme, the results obtained in this study were compared to data from literature. Most correlations in literature are for the second order reaction rate constant for the amine. By multiplying this constant with the amine concentration as used in the experiment, the corresponding second order overall reaction rate constant is obtained. It was concluded that the results of the present experiments are well in line with data found in literature.

Experiments were performed on alkanolamine absorption solutions in presence of the enzyme carbonic anhydrase. Studied alkanolamines include diethylethanolamine (DEMEA), dimethylethanolamine (DMMEA), monoethanolamine (MEA), triethanolamine (TEA) and tri-isopropanolamine (TIPA).

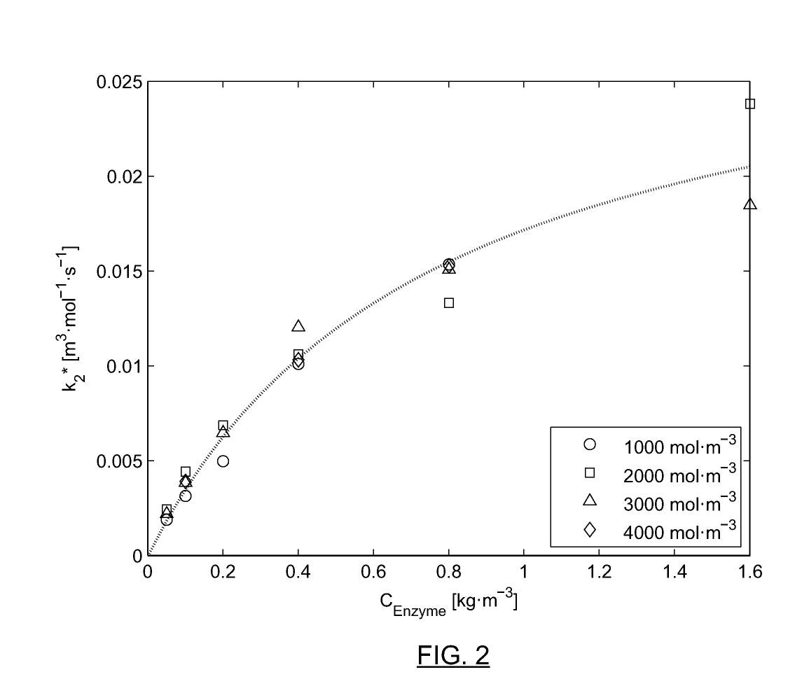

Referring to FIG. 2, experiments with MDEA show that the dependency between the absorption reaction rate and the enzyme concentration C_{Enzyme} is linear at low concentrations and this dependency is deviated at higher concentrations. This behaviour may be extended to other absorption solutions. The experimental data of k₂* in 10⁻³ m³·mol⁻·s⁻¹ for several enzyme concentrations in MDEA solution are provided in Table 2.

TABLE 2

| | |
|---|---|
| C_{MDEA} | C_{Enzyme} [kg · m³] |

| mol · m³ | 0. [symbol] 5 | 0.1 | [symbol] .2 | 0.1 | [symbol] .8 | 1.6 |
|---|---|---|---|---|---|---|
| 100 [symbol] | 1.90 | 3.26 | 5.23 | 9.90 | 15. [symbol] | 21.0 |
| 200 [symbol] | 2.11 | [symbol] | 6.88 | 10.6 | 13.3 | 23.8 |
| 300 [symbol] | 2.21 | 3.86 | 6.18 | 12.0 | 15.1 | 18.5 |
| 400 [symbol] | | 3.91 | | 10.3 | 15.3 | |

[symbol]

indicates data missing or illegible when filed

The following empirical Equation (1) may be used for illustrating the dependency between k₂* and the enzyme concentration.

$${k}_{2}^{*} = \frac{{k}_{3}^{*} {C}_{Enzyme}}{1 + {k}_{4}^{*} {C}_{Enzyme}} \qquad Equation ( 1 )$$

wherein k₂* is the enzyme enhanced reaction rate constant in m³/mol/s;
k₃* is a kinetic constant related to the combination enzyme-absorption compound in m⁶/mol/g/s;
k₄* is a kinetic constant related to the combination enzyme-absorption compound in m³/g; and
C_{Enzyme} is the concentration of the enzyme in mol/m³.

The absorption reaction rate is therefore dependent on the enzyme concentration and a combined effect between the carbonic anhydrase and the absorption solution. The combined effect can be described and quantified by a pair of constants (k₃*, k₄*).

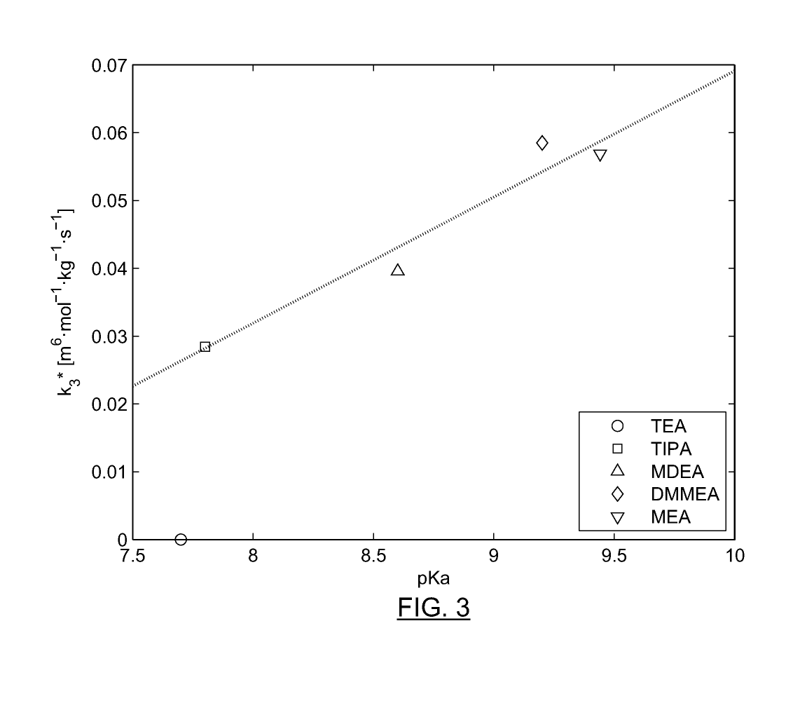

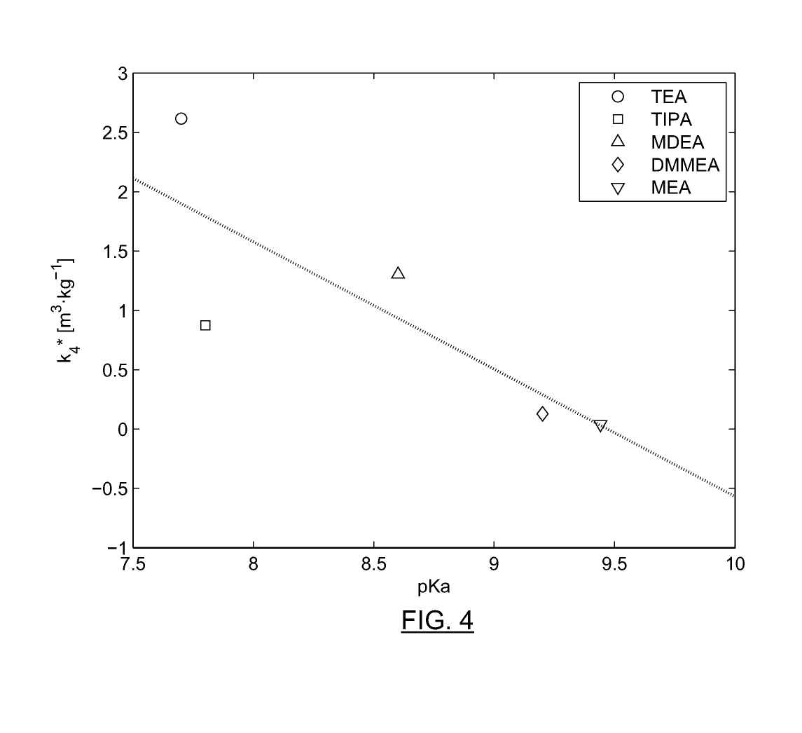

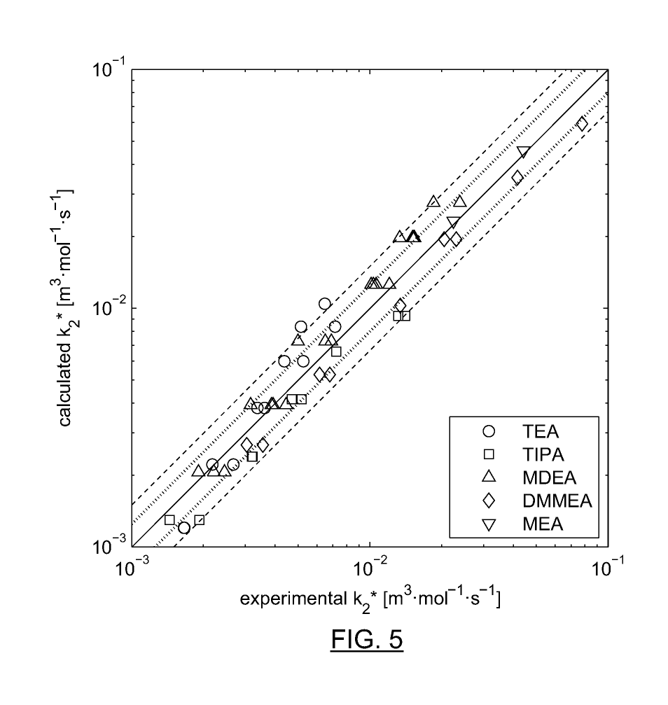

Constants k₃* and k₄* may be derived from experimental data with derivation methods, such as the least squares method or the linear regression method. FIGS. 3 and 4 illustrate the correlation between experimental data and empirical Equation (1) according to the least squares method. FIGS. 5 to 7 illustrate the correlation between experimental data and empirical Equation (1) according to the linear regression method.

In some implementations, there is provided techniques for coordinating the acidity of the absorption solution with the character and concentration of the enzyme.

For identified (k₃*, k₄*) pairs, a relationship between the kinetic constants (k₃*, k₄*) and a pKa value of the absorbing compounds, such as an alkanolamine, has been found. More particularly, this relationship may be linear, as shown in FIGS. 3, 4, 6 and 7 and expressed in the following Equations (2) and (3).

k₃*=A₃+B₃ pKa Equation (2)

k₄*=A₄+B₄ pKa Equation (3)

wherein (A₃, B₃) and (A₄, B₄) are pairs of coefficients characterizing the enzyme.

As mentioned above, the following describes the least squares method and the linear regression method for obtaining coefficients A and B.

Least Squares Method:

From the experimental data shown in FIG. 2, values of k₃* and k₄* have been determined for each tested alkanolamine with the least squares method. Results are gathered in the following Table 3.

TABLE 3

| | | k₃* | k₄* | |
|---|---|---|---|---|
| amine | pKa | m⁶ · mol⁻¹ · kg⁻¹ · s⁻¹ | m³ · kg⁻¹ | error % |
| TEA | 7.7 | 0.027 | 2.62 | 7 |
| TIPA | 7.8 | 0.028 | 0.874 | 12 |
| MDEA | 8.6 | 0.040 | 1.31 | 10 |
| DMMEA | 9.2 | 0.058 | 0.130 | 8 |
| MEA | 9.44 | 0.057 | 0.040 | 0 |

Referring to FIGS. 3 and 4, each value of (k₃*, k₄*) pairs have been plotted versus the pKa of tested alkanolamines. A linear relationship is therefore set and the following pairs of constants (A₃, B₃) and (A₄, B₄) are found.

k₃*=1.8597·10⁻²·pKa−0.11683

k₄*=−1.073·pKa+10.162

wherein A₃=−0.11683 and B₃=1.8597·10⁻²; and A₄=10.162 and B₄=−1.073.

Linear Regression Method:

From the experimental data shown in FIG. 2, values of k₃* and k₄* have been determined for each tested alkanolamine with the linear regression method. The linear regression is illustrated in FIG. 5. Results are gathered in the following Table 4.

TABLE 4

| | | | | |
|---|---|---|---|---|
| | | k₃* | k₄* | |
| amine | pKa | m⁶ · mol⁻¹ · g⁻¹ · s⁻¹ | m³ · g⁻¹ | error % |

| | | | | |
|---|---|---|---|---|
| TEA | 7.7 | 0.041 | 6.02 | 12 |
| TIPA | 7.8 | 0.036 | 1.84 | 11 |
| MDEA | 8.6 | 0.047 | 2.12 | 10 |
| DMMEA | 9.2 | 0.067 | 0.350 | 8 |
| MEA | 9.44 | 0.057 | 0.040 | 0 |

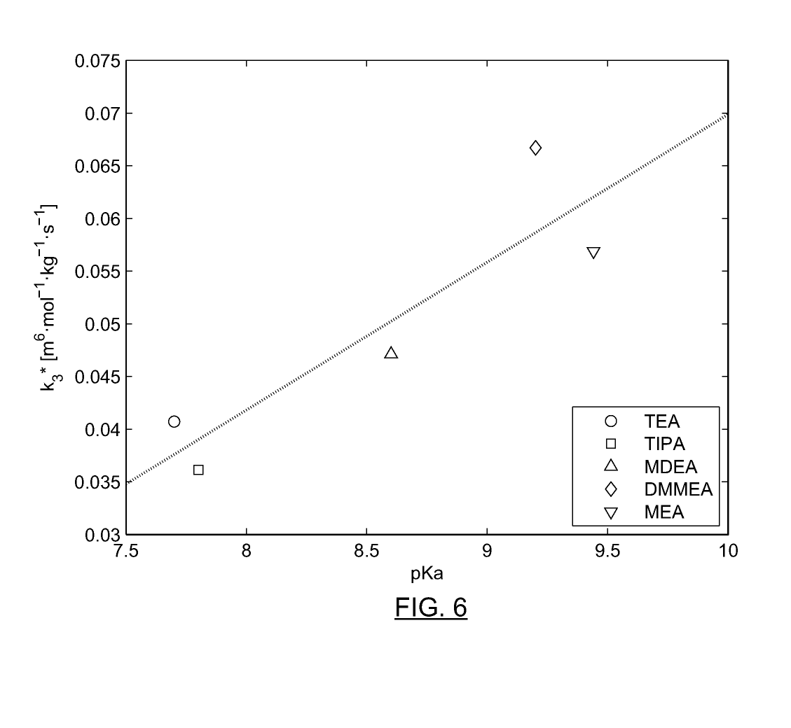

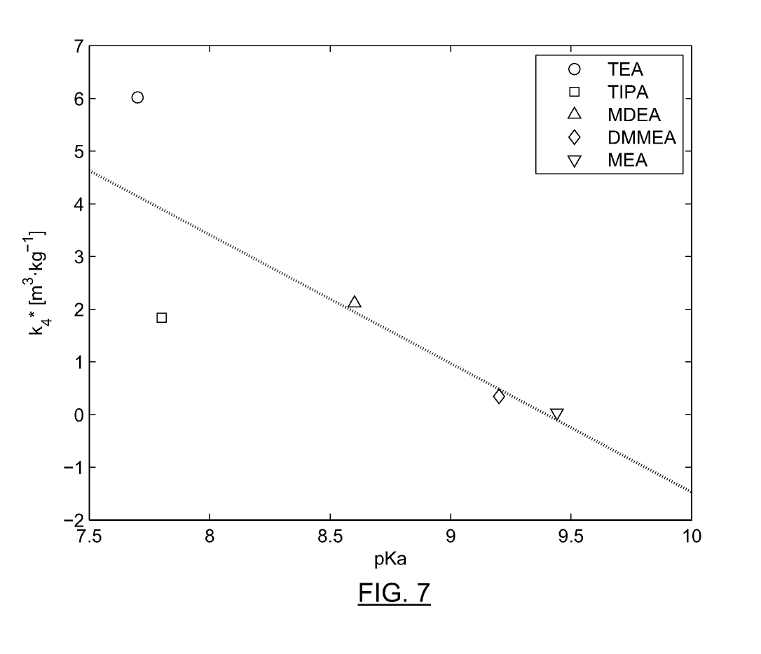

Referring to FIGS. 6 and 7, each value of (k₃*, k₄*) pairs have been plotted versus the pKa of tested alkanolamines. A linear relationship is therefore set and the following pairs of constants (A₃, B₃) and (A₄, B₄) are found.

k₃*=0.014033·pKa−0.07042

k₄*=−2.441·pKa+23.941

wherein A₃=−0.07042 and B₃=1.4033·10⁻²; and A₄=22.941 and B₄=−2.441.

In view of the above, in some scenarios, for a given enzyme such as a given strain, variant or batch of carbonic anhydrase, one may obtain the enzyme acidic character constants, such as A and B, in order to coordinate the given enzyme with an absorption solution acidity in order to obtain CO₂ capture kinetics.

In some implementations, one can achieve enhancing or maximizing the absorption reaction rate by selecting or controlling the acidity (pKa) of the absorption solution; the character of the enzyme; and/or the concentration of the enzyme.

In one example, the absorption compound may be selected based on its pKa in accordance with a particular enzyme's response characteristics to pKa. In another example, a carbonic anhydrase enzyme may be selected based on having a high A constant and low B constant. In another example, a mixture of multiple carbonic anhydrases may be used having different characters and A,B constants for a given absorption compound pKa.

In some scenarios, one may determine or approximate the kinetic constants (k₃*, k₄*, A, B, C, D) to facilitate selection of one or more absorption compounds and/or enzyme to be used in a CO₂ capture system.

In some scenarios, one may determine or approximate the kinetic constants (k₃*, k₄*, A, B, C, D) to facilitate operation of a CO₂ capture system that uses an absorption compound and an enzyme. An existing CO₂ capture system, which may include absorption and desorption reactors and may be similar to the system shown in FIG. 1, may be retrofit or converted into an enzymatic CO₂ capture system by using the design and operation knowledge of the relationship between the kinetics of the CO₂ absorption, the carbonic anhydrase and the pKa of the absorption solution.

In some scenarios, techniques described herein can allow the efficient design, operation or control of a CO₂ capture system while avoiding guesswork and trial and error. For example, in a case where a new type of enzyme is to be used in a CO₂ capture system, its different acidic response character may be accounted for by determining a desired pKa or acidity and a desired enzyme concentration according to the derived relationship to maintain a high or constant level of CO₂ capture.

In some scenarios, multiple different carbonic anhydrase types having different characters may be selected for use with a certain absorption solution. For example, since the cost of absorption compounds can vary, it may be desirable to modify the composition of the absorption solution to provide a more cost effective system. Such modifications may reduce the acidity of the modified solution which, in turn, would modify the kinetic constants associated with the enzyme. One may therefore modify the enzyme type or add additional enzyme(s) of different type and character to correct for the modified absorption solution while maintaining suitable absorption kinetics.

In some scenarios, the coordinating of the pKa or acidic character of the absorption solution with the enzyme may be done by using experimental protocols, such as determining kinetic constants of the absorption reaction rate according to solving approaches for overdetermined systems in data fitting, such as the least squares method or linear regression method. The coordinating may also be done based on generated or pre-determined charts or graphs of kinetic constants versus pKa for different enzymes. The coordinating of the pKa or acidic character of the absorption solution and the enzyme may include selecting an enzyme and providing the enzyme in a concentration sufficient for accelerating the absorption reaction according to the pKa of the absorption solution.

Various different types of absorption compounds may be used. For example: amine solutions, alkanolamine solutions, aminoether solutions, carbonate solutions, amino acid solutions, and so on. In some optional aspects, the absorption solution may include a chemical compound for enhancing the CO₂ capture process. For instance, the ion-rich solution may further contain at least one compound selected from the following: piperidine, piperazine, derivatives of piperidine or piperazine which are substituted by at least one alkanol group, monoethanolamine (MEA), 2-amino-2-methyl-1-propanol (AMP), 2-(2-aminoethylamino)ethanol (AEE), 2-amino-2-hydroxymethyl-1,3-propanediol (Tris), N-methyldiethanolamine (MDEA), dimethylmonoethanolamine (DMMEA), diethylmonoethanolamine (DEMEA), triisopropanolamine (TIPA), triethanolamine (TEA), DEA, DIPA, methyl monoethanolamine (MMEA), TIA, TBEE, HEP, AHPD, hindered diamine (HDA), bis-(tertiarybutylaminoethoxy)-ethane (BTEE), ethoxyethoxyethanoltertiarybutylamine (EEETB), bis-(tertiarybutylaminoethyl)ether, 1,2-bis-(tertiarybutylaminoethoxy)ethane or bis-(2-isopropylaminopropyl)ether, and the like, dialkylether of polyalkylene glycols, dialkylether or dimethylether of polyethylene glycol, amino acids including glycine, proline, arginine, histidine, lysine, aspartic acid, glutamic acid, methionine, serine, threonine, glutamine, cysteine, asparagine, valine, leucine, isoleucine, alanine, valine, tyrosine, tryptophan, phenylalanine, and derivatives such as taurine, N,cyclohexyl 1,3-propanediamine, N-secondary butyl glycine, N-methyl N-secondary butyl glycine, diethylglycine, dimethylglycine, sarcosine, methyl taurine, methyl-α-aminopropionic acid, N-(β-ethoxy)taurine, N-(β-aminoethyl)taurine, N-methyl alanine, 6-aminohexanoic acid and potassium or sodium salts of the amino acids, or mixtures thereof. The solution may include primary, secondary and/or tertiary alkanolamines. The solution may include hindered alkanolamine and/or hindered aminoether.

In another optional aspect, the solution may be a carbonate-based solution, such as potassium carbonate solution, sodium carbonate solution, ammonium carbonate solution, promoted potassium carbonate solutions, promoted sodium carbonate solutions or promoted ammonium carbonates; or mixtures thereof. These carbonate-based solutions may be promoted with one or more of the above-mentioned chemical compounds.

The enzyme may be provided in a concentration between about 0.05 kg/m³ and 2 kg/m³. Optionally, the enzyme may be provided in a concentration of at least 0.2 kg/m³.

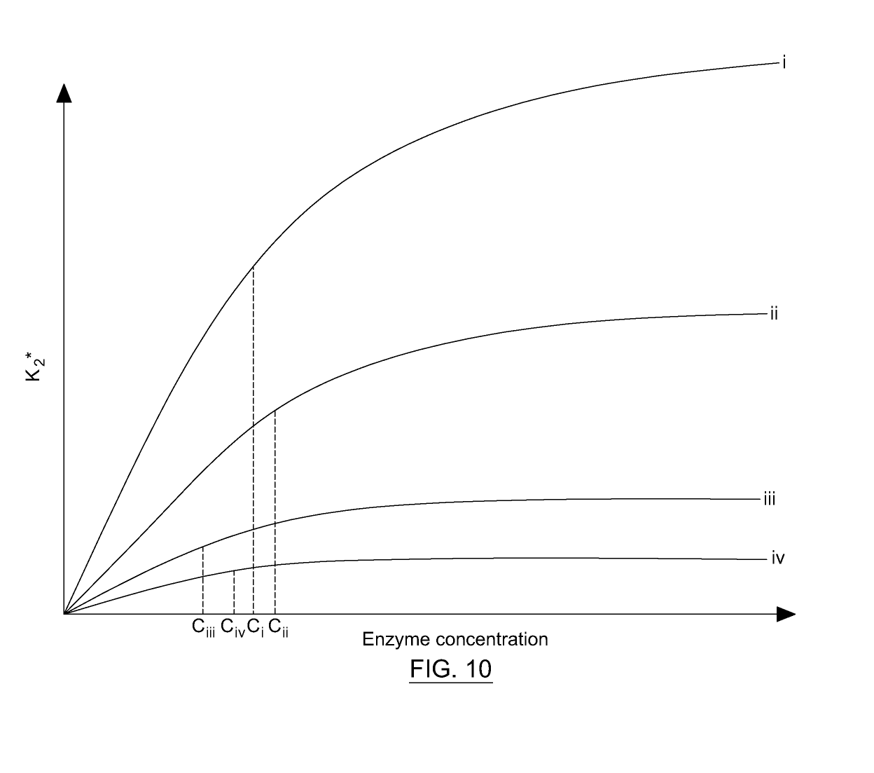

Referring to FIG. 10, comparison of different enzymes (i) to (iv) may be done using the relationship. In some scenarios, due to the form of the relationship between k₂* and enzyme concentration, the process may be provided at k₃ dominant conditions. When k₃^{*} is the dominant constant, the relationship between k₂* and enzyme concentration is substantially linear. At higher enzyme concentrations, the denominator of the formula becomes higher than 1, and k₄* becomes a more relevant constant. Depending on the relationship, it may be desirable in some cases to provide a maximum enzyme concentration within k₃^{*} dominated conditions. FIG. 10 shows the enzyme concentrations Cᵢ to Cᵢᵥ that are approximately maximum concentrations within k₃^{*} dominated conditions. The carbonic anhydrase or analog thereof may be provided in a concentration for maximizing k₂* while being sufficiently low such that k₂* is substantially proportional to k₃*C_{Enzyme} and k₄*C_{Enzyme} is lower than 1. In some scenarios, with a set of curves for several solutions, the relationships may be used to determine optimal enzyme-solution combinations to increase or maximize global solution absorption performance.

It should be understood that various techniques described herein are not limited to CO₂ absorption but include CO₂ desorption processes and related systems and solutions. Enhancement of the backward dehydration reaction kinetics should also be facilitated by the techniques described herein in a similar manner to enhancement of the forward hydration reaction.

It should also be understood that any one of the above mentioned aspects of each method, process, use and solution may be combined with any other of the aspects thereof, unless two aspects clearly cannot be combined due to their mutually exclusivity. For example, the various embodiments of the method for enhancing or maximizing a capture rate of CO₂ described herein-above, herein-below, in the appended Figures and/or in the appended claims, may be combined with any of the process for absorbing CO₂ from a CO₂-containing gas, method for controlling the reaction rate of CO₂ hydration, use of at least one absorption compound appearing herein and/or in accordance with the appended claims.

### Some Additional Information Regarding Temperature Relationships

In other examples, CO₂ absorption experiments were performed with a 0.3 M sodium carbonate solution containing 0, 400, 800, 1600 or 2400 g·m⁻³ of the enzyme carbonic anhydrase at 298, 313 or 333 K.

The anhydrous sodium carbonate used for the preparation of the aqueous solutions had a purity of >99% and it was used as supplied by Merck. The enzyme used was a thermostable carbonic anhydrase provided by Codexis inc. in a purified form. All solutions were prepared with demineralized water. The carbon dioxide (99.9%) was obtained from Air Liquide.

TABLE 5
Distribution coefficient of carbon dioxide for the test conditions

| Temperature | m |
|---|---|
| [K] | [—] |
| 298 | 0.68 |
| 313 | 0.52 |
| 333 | 0.38 |

The diffusion coefficient of carbon dioxide is estimated from the solution's viscosity using the Stokes-Einstein relationship:

$${D}_{CO 2 , Na 2 CO 3} = {D}_{CO 2 , water} \cdot \frac{{η}_{water}}{{η}_{Na 2 CO 3}} \qquad ( A )$$

TABLE 6
Viscosity and diffusivity of carbon dioxide for the test conditions

| | | D |
|---|---|---|
| Temperature | η | [·10⁻⁹m² · |
| [K] | [mPa · s] | s⁻¹] |
| 298 | 1.04 | 1.63 |
| 313 | 0.77 | 2.34 |
| 333 | 0.54 | 3.66 |

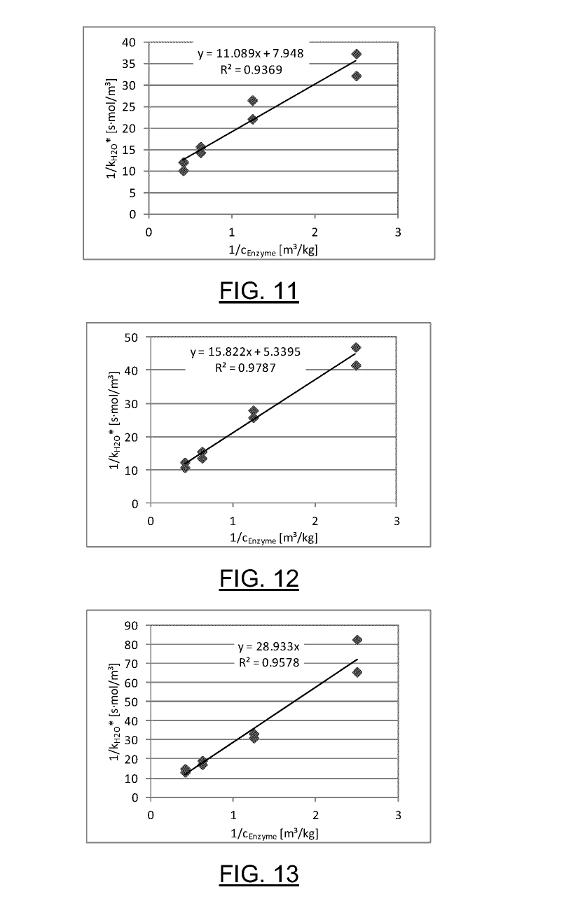

FIG. 11, FIG. 12 and FIG. 13 present the plots of the experimental of the experiments at 298, 313 and 333 K respectively.

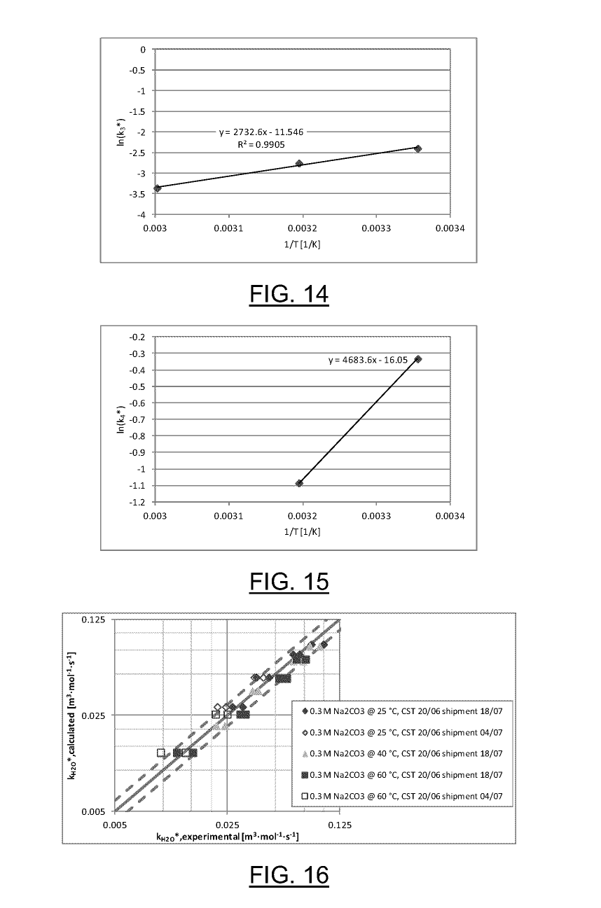

The results for the rate constants k₃* and k₄* derived from the experimental results are presented in Table 7. FIGS. 14 and 15 show the Arrhenius plots for the rate constants.

TABLE 7
Experimental results for the rate constants k₃* and k₄*.

| T | k₃* | k₄* |
|---|---|---|
| [K] | [m⁶ · mol⁻¹ · kg⁻¹ · s⁻¹] | [m³ · kg⁻¹] |
| 298 | 0.0902 | 0.717 |
| 313 | 0.0632 | 0.337 |
| 333 | 0.0346 | 0 |

From the results presented in Table 7, FIG. 14 and FIG. 15, both rate constants are dependent on the temperature. The rate constants can be calculated with the two following equations:

$$\begin{matrix}{k}_{3}^{*} ( T ) = 9.67 \cdot {10}^{- 6} \cdot exp ( \frac{2732.6}{T} ) & ( B ) \\ {k}_{4}^{*} ( T ) = 1.07 \cdot {10}^{- 7} \cdot exp ( \frac{4683.6}{T} ) & ( C )\end{matrix}$$

Substituting equations (B) and (C) into equation:

$${E}_{CO 2} = Ha = \frac{\sqrt{{k}_{1} {D}_{CO 2}}}{{k}_{L}}$$

gives the following correlation for the enzymatic rate constant:

$${k}_{H 2 O}^{*} = \frac{9.67 \cdot {10}^{- 6} \cdot exp ( \frac{2732.6}{T} ) \cdot {C}_{Enz}}{1 = 1.07 \cdot {10}^{- 6} \cdot exp ( \frac{4683.6}{T} ) \cdot {C}_{Enz}} \qquad ( D )$$

With these equations the enzymatic rate constant k_{H2O}* was estimated within an accuracy of 20% or 40%.

It should be understood that k_{H2O}* calculated with equation (D) as mentioned above is equivalent to k₂* characterizing the enzyme catalysed hydration reaction rate. k_{H2O}* may be defined by the ratio of k_{H2O} on C_{H2O}. It should further be noted that k_{H2O} may be referred to as k′_{H2O}.

Additional Experiments and Results with Enzymatically Enhanced CO₂ Capture with Carbonic Anhydrase

### Absorption Rate in MDEA (N-methyldiethanolamine)

CO₂ absorption experiments in MDEA were conducted with the following scope:
Determination of the reaction rate constant in solutions without enzyme; and
Determination of effect of enzyme addition on the CO₂ absorption rate.

The following experiments were performed using CO₂ and MDEA. Results are gathered in Table 8.

TABLE 8
C_{hCA II}

| | | | | | | 1000- |
|---|---|---|---|---|---|---|
| C_{MDEA}, N | no | 10 mg/l | 100 mg/l | 250 mg/l | 500 mg/l | mg/l |
| 2M, 50 rpm | x | x | x | | | |
| 2M, 100 rpm | x | | x | x | x | x |
| 4M, 100 rpm | x | | | | x | |

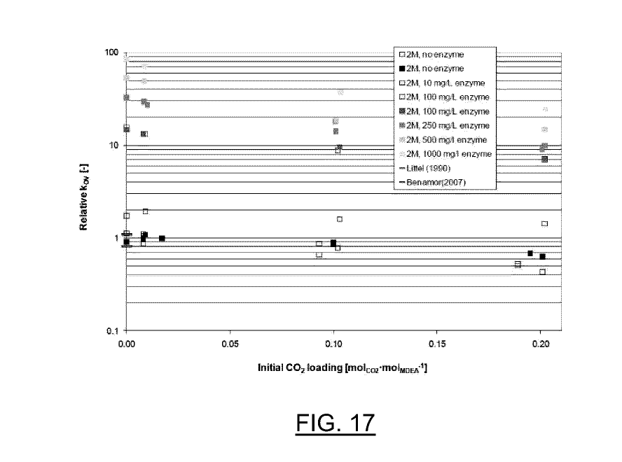

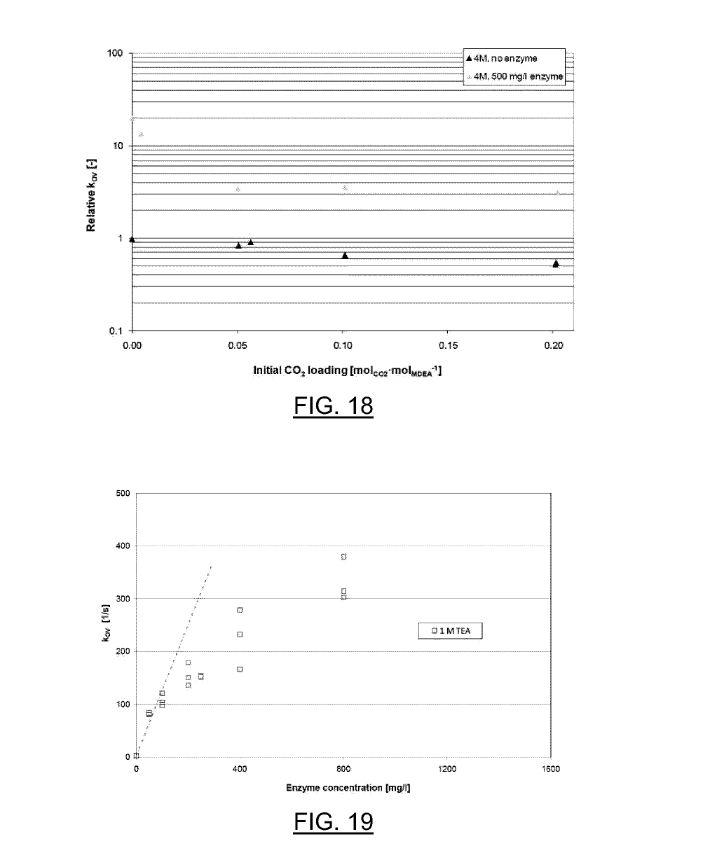

Results of the absorption experiments with MDEA of Table 8 are presented in FIG. 17 and FIG. 18. The results of the chemical enhancement factor are presented in the table further below.

FIG. 17 is a graph of relative k_{OV} versus initial CO₂ loading in an enzyme and MDEA solution, more specifically the results of the CO₂ absorption experiments with 2 M MDEA and hCA II carbonic anhydrase enzyme. The open squares are results of experiments performed at 50 rpm and the filled squares at 100 rpm in the batch reaction vessel (FIG. 9).

FIG. 17 shows that the results are reproducible and that at low CO₂ loading (a 0.01 mol CO₂/mol MDEA) the k_{OV} measured in this experiment is well in line with literature correlations. FIG. 17 also shows that the stirrer speed and therewith k_{L} have no influence on the reaction rate constant. This is an indication that the experiments were performed in the regime of pseudo first order kinetics. FIG. 17 also shows that at comparable CO₂ loading k_{OV} increases with increasing enzyme concentration in the solution and that at increasing CO₂ loading k_{OV} decreases. The free amine concentration in the solution decreases with increasing CO₂ loading.

FIG. 18 is a graph showing the results of absorption experiments with 4 M MDEA. FIG. 18 shows the results are reproducible. FIG. 18 also shows that at increasing CO₂ loading k_{OV} decreases. The free amine concentration in the solution decreases with increasing CO₂ loading. FIG. 18 also shows that at comparable CO₂ loading, k_{OV} increases in presence of enzyme concentration in the solution.

Comparing FIGS. 17 and 18, it appears that the increase in k_{OV} on addition of 500 mg/L enzyme is less with the 4 M solution than with the 2 M MDEA solution. Whereas the rate for CO₂ absorption in the 2 M MDEA solution increased with a factor 50, for the 4 M MDEA solution the increase was a factor 5.

When 4 M MDEA with 500 mg/I enzyme hCA II solution was drained from the reactor after the experiments, some degree of denaturation seemed to have occurred. This seems a likely explanation for the relatively small increase in k₂ upon addition of CA.

The following table 9 shows enhancement factors for unloaded 2M MDEA solutions with different enzyme concentrations.

TABLE 9

| Enzyme concentration (mg/L) | Enhancement factor (E) |
|---|---|
| 0 | 9.4 |
| 100 | 54.1 |
| 250 | 76.4 |
| 500 | 88.6 |

From Table 9, it can be drawn that E increases with increasing enzyme concentration in the solution. The k_{L} slightly decreases by the presence of enzyme, while k_{OV} increases significantly.

### Absorption Rate in TEA (Triethanolamine)

TEA is also a tertiary alkanolamine. It has a lower pKa than MDEA and hence a lower reactivity towards CO₂. The molecular weight of TEA is slightly higher than that of MDEA, and hence the variation in water concentration is a little more pronounced in this set of experiments.

Absorption rate experiments were conducted at TEA concentrations of 1, 2 and 4 kmol/m³ and at enzyme concentrations up to a maximum of about 1600 mg/L.

The TEA concentrations and corresponding water concentrations are presented in the following table along with the values for the physico-chemical constant (m·√D) used to interpret the absorption rate experiments. Also, in this table, the second-order kinetic rate constants of the reaction between TEA and CO₂-k₂—are listed.

TABLE 10
Water concentration and m · √D at used TEA concentrations

| C_{TEA} | | | |
|---|---|---|---|
| [kmol m⁻³] | C_{H2O} [kmol m⁻³] | m · √D [m · s^{-1/2}] | k₂ [m³ kmol⁻¹ s⁻¹] |
| 1.0 | 48 | 2.63 · 10⁻⁵ | 2.3 |
| 2.0 | 41 | 1.99 · 10⁻⁵ | 2.7 |
| 4.0 | 27 | 1.03 · 10⁻⁵ | 1.8 |

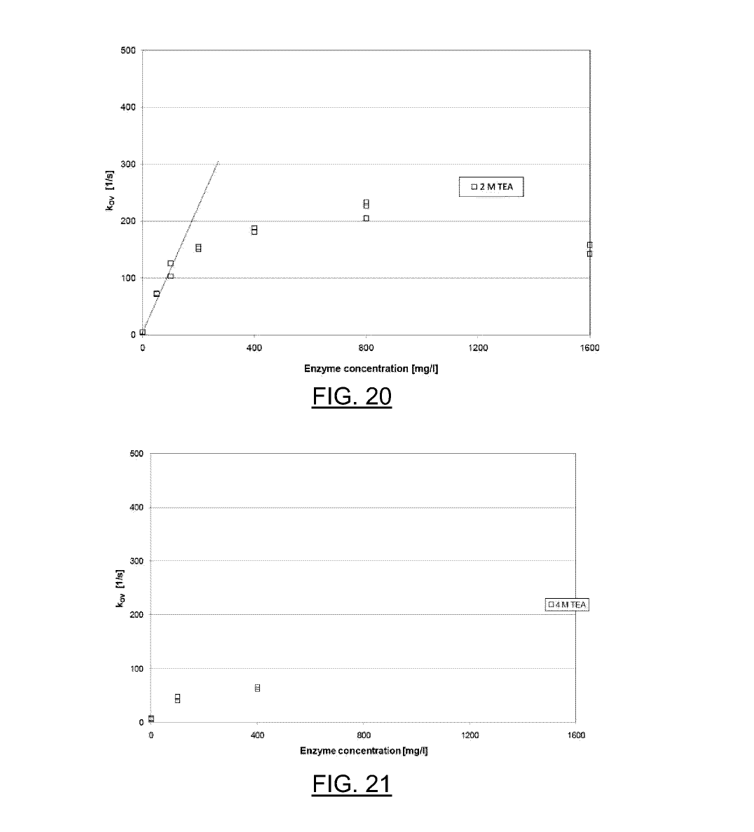

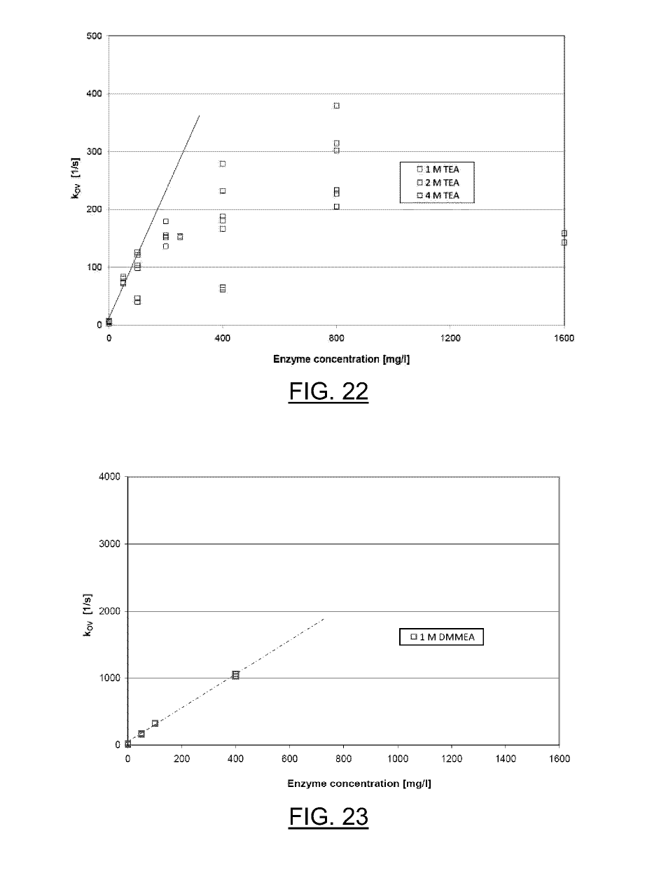

FIGS. 19 to 22 show the results. From the results of Table 10 reported in FIGS. 19 to 22, the following trends were observed. First, the overall kinetic rate constant increases with M5X enzyme concentration. However, the linear dependency between k_{OV} and enzyme concentration, as observed for MDEA, is observed for a smaller concentration range. Second, at enzyme concentrations ranging from 50 to 400 mg/L, there appears to be no difference in result between 1.0 and 2.0 kmol/m³ TEA. In addition, at an enzyme concentration of 800 mg/L, there is a considerable difference in k_{OV} between 1.0 and 2.0 kmol/m³ TEA. Furthermore, the overall rate constants obtained with the catalyzed 4.0 kmol/m³ TEA solutions are remarkably lower than both other concentrations studied. In addition, the overall kinetic rate constant seems to level off at higher enzyme concentrations. This levelling off seems to be more distinct with increasing amine concentration. Overall, the absolute increase in overall kinetic rate constant is less than in the case of MDEA.

In relation to the mechanistic study, it can be said that at certain experimental conditions (i.e. C_{TEA}=1.0 & 2.0 kmol/m³ and 50≦C_{M5X}≦400 mg/L), the observed k_{OV} seems not a function of TEA concentration and hence it may be concluded that the overall kinetic rate constant is (predominantly) determined by the contribution of the (catalyzed) reaction between water and CO₂, and therefore k_{OV}=k_{H2O}. Also for these conditions, it can be said that the rate constant of the H₂O—CO₂ reaction is a function of the enzyme concentration and that the rate constant of the H₂O—CO₂ reaction seems not a function of TEA and water concentration. Outside these conditions, the overall rate constant seems to be decreasing with increasing TEA concentration. This may be the influence of the simultaneously decreasing water concentration having its effect on the H₂O—CO₂ reaction rate, but also enzyme denaturation effects cannot be ruled out at this point. In addition, the catalyzing effect of M5X seems to be dependent on the pKa of the alkanolamine in solution.

### Absorption Rate in DMMEA (Dimethylethanolamine)

DMMEA is another tertiary alkanolamine and has a higher pKa than MDEA and hence a higher reactivity towards CO₂. The molecular weight of DMMEA is relatively low, resulting in just a slight variation in water concentration in this set of experiments.

Absorption rate experiments were conducted at DMMEA concentrations of 1 and 2 kmol/m³ and at enzyme concentrations up to a maximum of about 1600 mg/L.

The DMMEA concentrations and corresponding water concentrations are presented in the following table along with the values for the physico-chemical constant (m·√D) used to interpret the absorption rate experiments. Also, in this table, the second-order kinetic rate constants of the reaction between DMMEA and CO₂-k₂—are listed.

TABLE 11
Water concentration and m · √D at used DMMEA concentrations

| C_{DMMEA} | | | |
|---|---|---|---|
| [kmol m⁻³] | C_{H2O} [kmol m⁻³] | m · √D [m · s^{-1/2}] | k₂ [m³ kmol⁻¹ s⁻¹] |
| 1.0 | 51 | 3.05 · 10⁻⁵ | 19.5 |
| 2.0 | 47 | 2.40 · 10⁻⁵ | 18.8 |

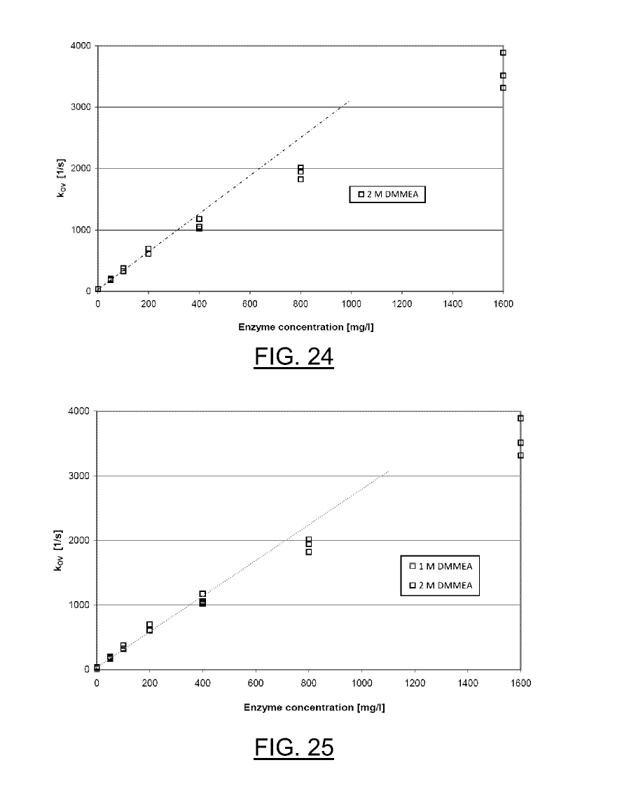

FIGS. 23 to 25 show the results. From the results of Table 11 reported in FIGS. 23 to 25, the following trends can be observed. First, the overall kinetic rate constant increases with M5X enzyme concentration. The linear dependence between k_{OV} and enzyme concentration holds for a larger concentration range than in the case of TEA and MDEA. Second, the overall kinetic rate constant does not seem a function of the alkanolamine concentration at the enzyme concentrations studied (≧50 mg/L). Furthermore, the overall kinetic rate constant levels off at a higher enzyme content as compared to the cases of MDEA and TEA. In addition, the effect of M5X is much more pronounced in the case of DMMEA than in the cases with MDEA and TEA.

In relation to the mechanistic study, it can be said that as the observed k_{OV} is not a function of DMMEA concentration (in case C_{M5X}≧50 mg/L), it can be concluded that the overall kinetic rate constant is (predominantly) determined by the contribution of the (catalyzed) reaction between water and carbon dioxide, and therefore k_{OV}=k_{H2O}. In addition, the rate constant of the H₂O—CO₂ reaction is a function of the enzyme concentration. Also, the rate constant of the H₂O—CO₂ reaction seems not a function of DMMEA and water concentration. It should be noted, however, that the water concentration was only slightly varied in this set of experiments. In addition, the catalyzing effect of M5X seems to be dependent on the pKa of the alkanolamine in solution: it increases with increasing pKa as observed in the order DMMEA>MDEA>TEA.

### Absorption Rate in DEMEA (Diethylmonoethanolamine)

DEMEA is also tertiary alkanolamine and has an even higher pKa than DMMEA and hence a higher reactivity towards CO₂. The molecular weight of DEMEA is comparable to MDEA.

Absorption rate experiments were conducted at DEMEA concentrations of 0.5, 1 and 2 kmol/m³ due to the possibility of enzyme denaturation in the presence of this amine.

The DEMEA concentrations and corresponding water concentrations are presented in the following table along with the values for the physico-chemical constant (m·√D) used to interpret the absorption rate experiments. Also, in this table, the second-order kinetic rate constants of the reaction between DEMEA and CO₂-k₂—are listed.

TABLE 12
Water concentration and m · √D at used DEMEA concentrations

| C_{DEMEA} | | | |
|---|---|---|---|
| [kmol m⁻³] | C_{H2O} [kmol m⁻³] | m · √D [m · s^{-1/2}] | k₂ [m³ kmol⁻¹ s⁻¹] |
| 0.5 | 52 | 3.14 · 10⁻⁵ | 33.0 |
| 1.0 | 48.5 | 2.67 · 10⁻⁵ | 35.5 |
| 2.0 | 42 | 2.02 · 10⁻⁵ | 33.1 |

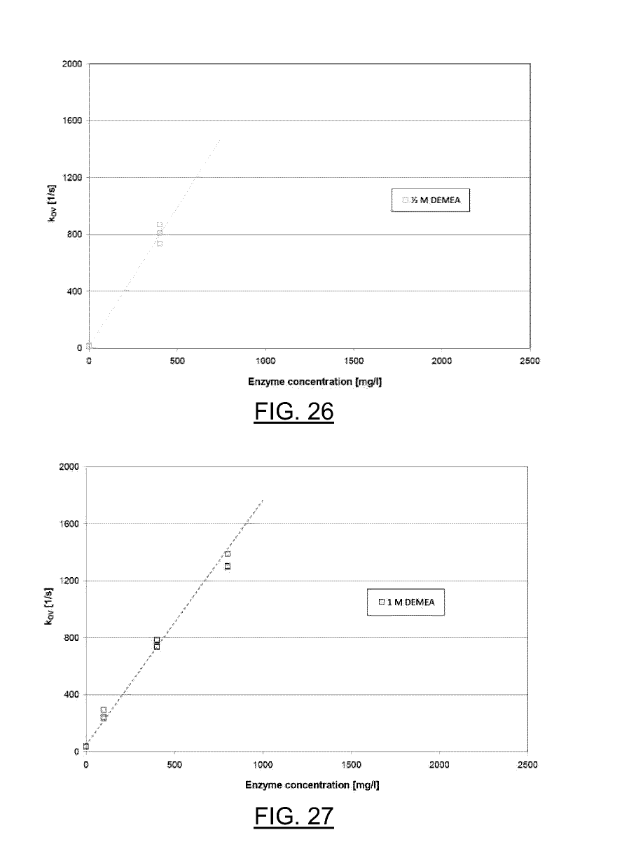

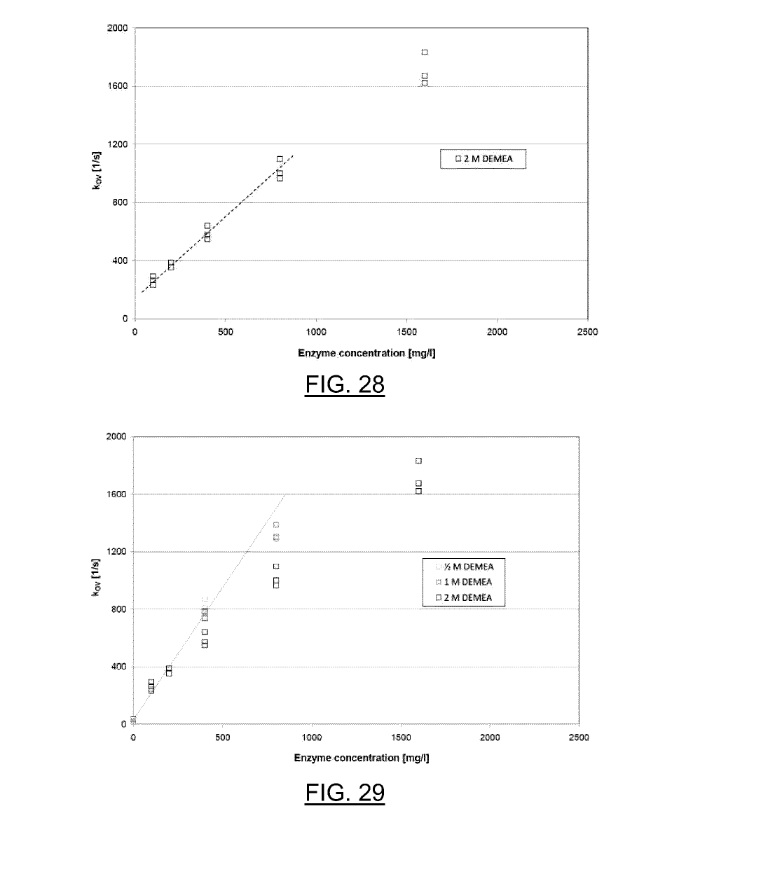

FIGS. 26 to 29 show the results. From the reported results of Table 12, the following trends can be observed. First, the overall kinetic rate constant increases with M5X enzyme concentration. As in the case of DMMEA, the linear relation between k_{OV} and enzyme concentration holds for a larger range than in the cases of MDEA and TEA. Second, the overall kinetic rate constant does seem a function of the alkanolamine concentration at the enzyme concentrations studied. The experiments seem to show an increasing effect with increasing enzyme content. As in the case of DMMEA, the overall kinetic rate constant does not level off at high enzyme content as clearly as in the case of MDEA and TEA. In addition, the effect of M5X on the absorption rate into DEMEA is not as pronounced as in the case of DMMEA.

In relation to the mechanistic study, it can be said that the observed k_{OV} seems to be a function of DEMEA concentration, with the exception of the experiments performed with 100 mg/L M5X enzyme in solution. This may either indicate towards a water-concentration dependence or towards enzyme denaturation effects in the solutions. In addition, the catalyzing effect of M5X is less in DEMEA than in DMMEA despite its higher pKa. The effect is higher, though, than in solutions with MDEA and TEA.

### Absorption Rate in TIPA (Triisopropanolamine)

TIPA is another tertiary alkanolamine under study and it has a lower pKa than MDEA, comparable to TEA. TIPA has a lower reactivity towards CO₂. The molecular weight of TIPA, however, is much larger than that of MDEA, and hence the variation in water concentration is more pronounced in this set of experiments.

Absorption rate experiments were conducted at TIPA concentrations of 1 and 2 kmol/m³ and at enzyme concentrations up to a maximum of about 800 mg/L.

The TIPA concentrations and corresponding water concentrations are presented in the following table along with the values for the physico-chemical constant (m·√D) used to interpret the absorption rate experiments. Also, in this table, the second-order kinetic rate constants of the reaction between TIPA and CO₂-k₂—are listed.

TABLE 13
Water concentration and m · √D at used TIPA concentrations

| C_{TIPA} | | | |
|---|---|---|---|
| [kmol m⁻³] | C_{H2O} [kmol m⁻³] | m · √D [m · s^{-1/2}] | k₂ [m³ kmol⁻¹ s⁻¹] |
| 1.0 | 45 | 2.34 · 10⁻⁵ | 1.02 |
| 2.0 | 35 | 1.45 · 10⁻⁵ | 0.79 |

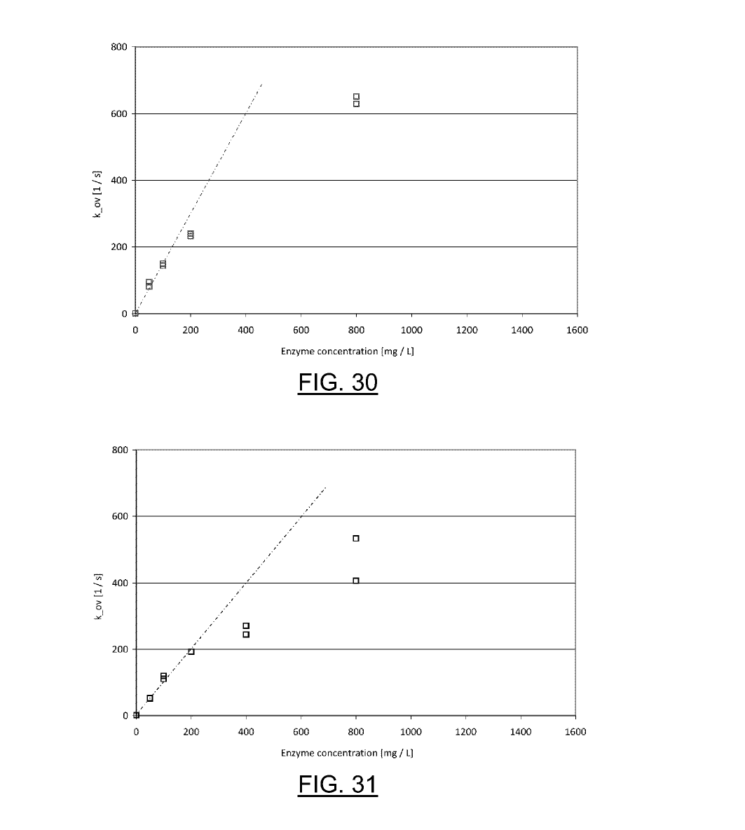

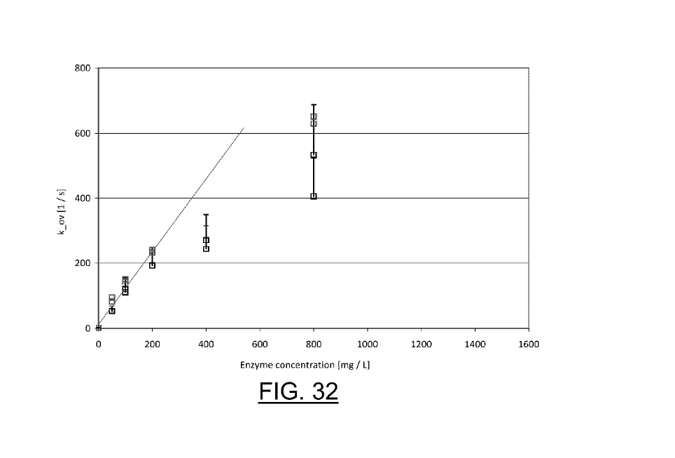

FIGS. 30 to 32 show the results. From the reported results of Table 13, the following trends can be observed. First, the overall kinetic rate constant increases with M5X enzyme concentration. The linearity between k_{OV} and enzyme concentration holds up to about 200 mg/L, which is in the same order of magnitude as observed in the case of TEA. Second, it may seem that the overall kinetic rate constant is a function of the TIPA concentration. However, it should be noted, that already in the “enzyme-free” solutions, a difference in rate constant was observed between 1.0 and 2.0 kmol/m³ TIPA (see TIPA table). This difference is most likely due to the physico-chemical properties (e.g. CO₂ diffusion coefficient), which are not known for the aqueous TIPA and hence had to be estimated. Taking this offset into account (via the error bars), it can be said that the influence of TIPA concentration is negligible at the enzyme concentrations studied (≧50 mg/L). In addition, the overall kinetic rate constant levels off at high enzyme content. Furthermore, the effect of M5X in aqueous TIPA is comparable to the effect observed in aqueous TEA. At e.g. 100 mg/L the observed k_{OV} amount to 110-150 s⁻¹ in the case of TIPA and 100-120 s⁻¹ in the case of TEA.

In relation to the mechanistic study, one can say that as the observed k_{OV} is not a function of TIPA concentration (in case C_{M5X}≧50 mg/L), it can be concluded that the overall kinetic rate constant is (predominantly) determined by the contribution of the (catalyzed) reaction between water and carbon dioxide, and therefore k_{OV}=k_{H2O}. In addition, the rate constant of the H₂O—CO₂ reaction is a function of the enzyme concentration and it levels off at higher enzyme concentration. Furthermore, the rate constant of the H₂O—CO₂ reaction seems not a function of TIPA and water concentration within the experimental conditions studied. In addition, the catalyzing effect of M5X seems to be dependent on the pKa of the alkanolamine in solution: it increases with increasing pKa as observed in the order DMMEA>MDEA>TIPA>TEA.

### Discussion of DMMEA, MDEA, TIPA and TEA Results

The main conclusions drawn from the experimental results presented herein-below are the following: first, in the presence of the (M5X) enzyme (≧50 mg/L), the overall kinetic rate constant is predominantly determined by the (enzyme catalyzed) reaction between carbon dioxide and water; the catalysis effect increases with increasing enzyme content (this effect, however, seems to level off at higher enzyme concentrations); and the catalysis effect increases with increasing pKa of the alkanolamine.

Another conclusion is further discussed in the following table and figures, in which the experimentally determined overall rate constants are listed as a function of pKa.

TABLE 14
Selection of results obtained with the tertiary alkanolamines

| | TEA | TIPA | MDEA | DMMEA | DEMEA |
|---|---|---|---|---|---|
| pKa | 7.72 | 7.82 | 8.56 | 9.22 | 9.75 |
| M5X [mg/L] | k_{OV} [s⁻¹] at alkanolamine concentration = 1.0 kmol m⁻³ | | | | |
| 50 | 82 | 88 | 100 | 169 | — |
| 100 | 108 | 147 | 187 | 325 | 257 |
| 200 | — | 236 | 251 | — | — |
| 400 | 226 | — | 460 | 1045 | 761 |
| M5X [mg/L] | k_{OV} [s⁻¹] at alkanolamine concentration = 2.0 kmol m⁻³ | | | | |
| 50 | 73 | 53 | 119 | 194 | — |
| 100 | 115 | 115 | 226 | 341 | 263 |
| 200 | 153 | 193 | 311 | 638 | 371 |
| 400 | 185 | 257 | 473 | 1082 | 588 |

### Absorption Rate Relative to MDEA Concentrations

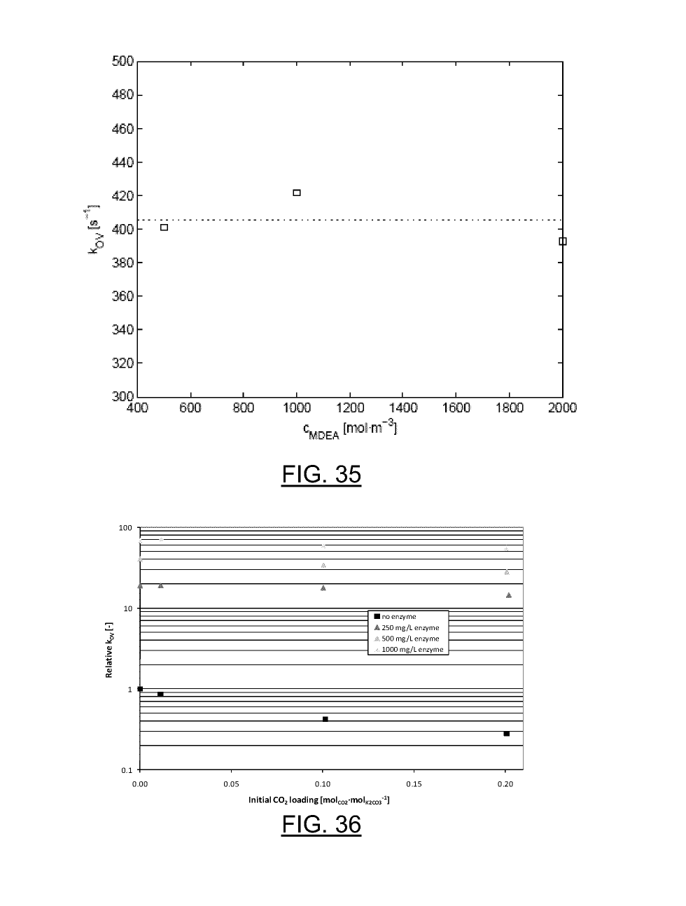

The effect of the amine concentration at a given, constant enzyme concentration was also studied. The results of these experiments are presented in FIG. 35. From these results, it can be concluded that the amine concentration has a negligible influence on the obtained overall reaction rate constant (see FIG. 35 for aqueous MDEA solutions and hCA II. Therefore, it seems that the enzyme do not enhance the reaction rate constant of Reaction I or II, k′_{Am}, as this constant is linearly dependent on the MDEA concentration as per a previous equation.

k_{OV}=k_{Am}C_{Am}+k_{OH}C_{OH}+k′_{H}_{₂}_{O}

Apparently, MDEA mainly acts as proton acceptor during the regeneration of the enzyme (see Reaction c). From these results, it can be concluded that the intermolecular H⁺ transport is not rate determining since the rate of this reaction is also dependent on the MDEA concentration. Therefore, it seems justified to conclude that Reactions I, II and IV occur in parallel and that the effect of the presence of the enzyme is taking place via Reaction IV. The experimentally determined values of k_{OV} are corrected for Reaction I and II via:

k_{OV} [symbol] =k_{OV}−k_{Am}C_{Am}

where k_{Am} is derived from the results obtained in this study, resulting in the following: k_{Am}=0.0064 m³mol⁻¹s⁻¹.

These experiments on the mechanism of enzyme catalysed carbon dioxide absorption into aqueous tertiary alkanolamines show that the enzyme does not catalyze Reaction I or II, the reaction between CO₂ and tertiary alkanolamine, since the overall reaction rate constant is not influenced by the amine concentration. The amine mainly acts as proton acceptor during the regeneration of the enzyme (Reaction b). Besides, this study also showed that Reactions I, II and IV, CO₂ hydrogenation, occur parallel, enzyme enhances Reaction IV and that Reaction IV is not only 1st order in CO₂, but also 1st order in H₂O. The enzyme carbonic anhydrase significantly increases kinetics of the absorption of carbon dioxide in aqueous MDEA solutions. Thus, the combination of CA with aqueous MDEA may provide a solution for the efficient capture of carbon dioxide from e.g. flue gases, since MDEA requires less energy for regeneration than MEA, the current industry benchmark.

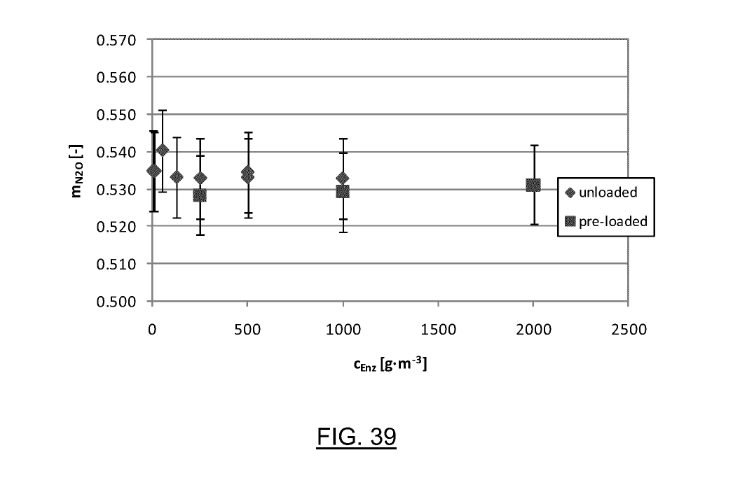

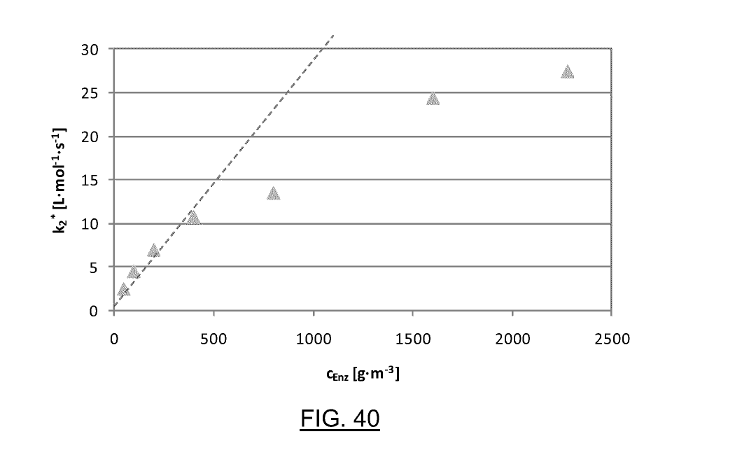

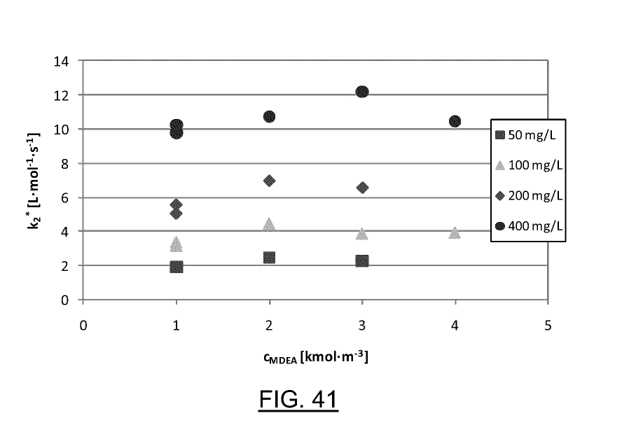

FIGS. 39, 40 and 41 also show results from experiments performed using MDEA.

Absorption Rate in AMP (amino-2-methyl-1-propanol)

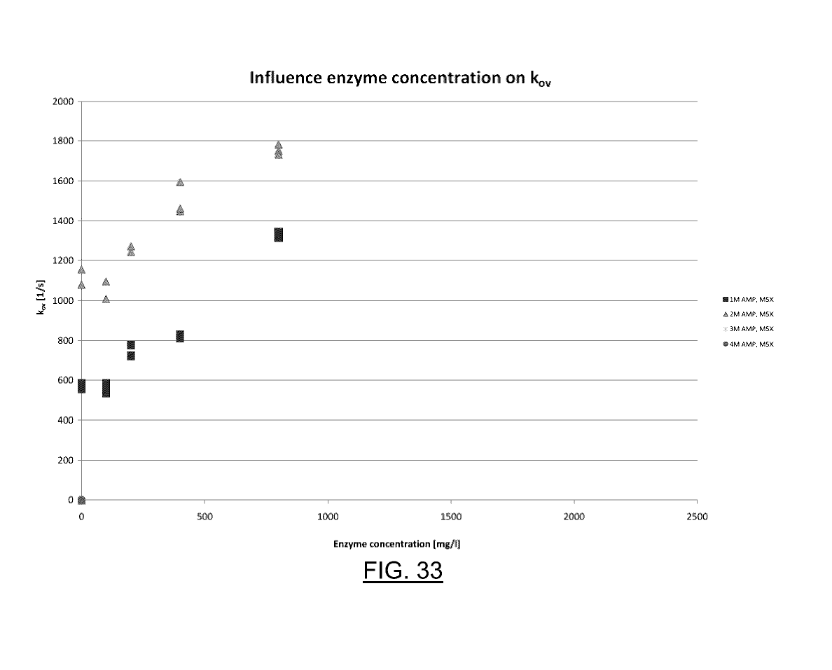

AMP is sterically hindered primary amine with a pKa higher than that of MDEA. FIG. 33 shows kₒᵥ values for 1 and 2 M AMP solutions with enzyme concentration ranging from 0 to 800 mg/L. As for the different tertiary amines, increase in enzyme concentration increases kₒᵥ of the solution. These results confirm that enzyme has impact in different amine types.

### Influence of Temperature on the Impact of Enzyme in MDEA Solutions

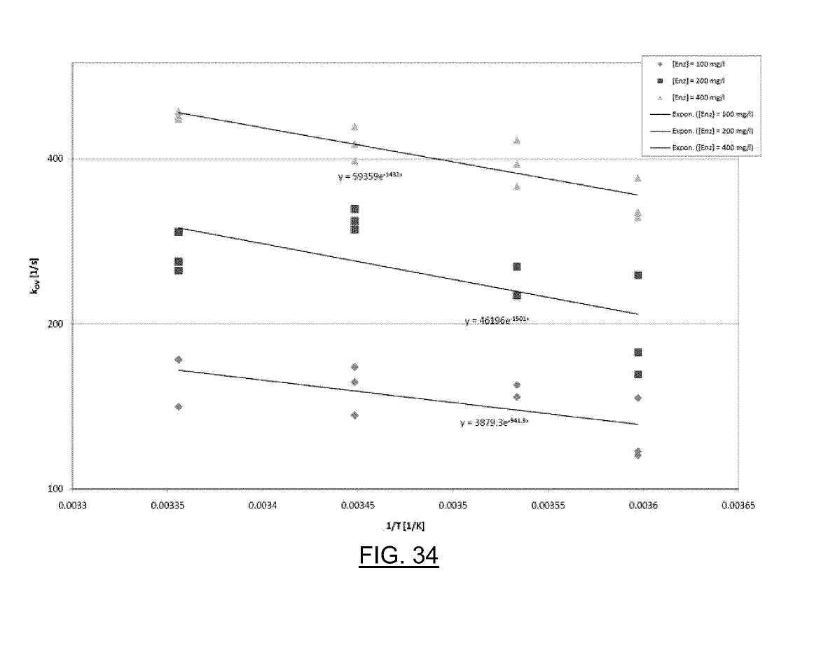

Tests were also conducted to determine the impact of the temperature on kₒᵥ values in enzyme enhanced 2 M MDEA solutions. FIG. 34 shows results for enzyme concentrations 100, 200 and 400 mg/L at temperatures ranging from 277 to 303 K. Temperatures were limited to this range to avoid any enzyme denaturation. However with a thermostable enzyme, enzyme could be used at higher temperatures. Data show that kₒᵥ increases at higher temperatures. Moreover, kₒᵥ increases with enzyme concentration for all temperatures.

### Absorption Rate in K₂CO₃

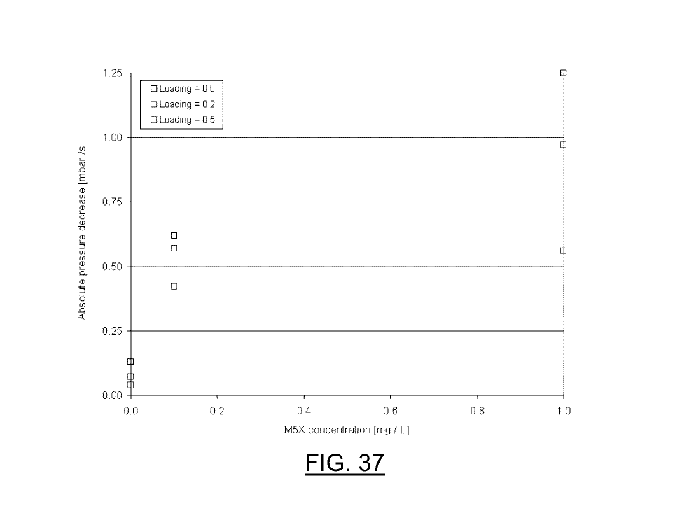

Impact of carbonic anhydrase was also evaluated in 1.45 M potassium carbonate solution at different CO₂ loadings and enzyme concentration. Results in FIG. 36 show that the general trends are identical to MDEA, the increase in absorption rate being in the same order of magnitude for both 1.45 M K₂CO₃ and 2 M MDEA.

### Absorption Rate in Na₂CO₃

Impact of carbonic anhydrase was also evaluated in 0.5 M sodium carbonate solution at different CO₂ loadings (0, 0.2 and 0.5) and enzyme concentrations (0, 0.1 and 1.0 g/L). Enzyme used is 5X developed by CO₂ Solution inc. Results in FIG. 37 show that the enzyme has an impact on CO₂ absorption rate in 0.5 M sodium carbonate solution. The impact of the enzyme on absorption rate (here referred to as pressure decrease) is not linear as it is also the case for amines and potassium carbonate. The curve is linear at low enzyme concentration but levels off when enzyme concentration is higher. From these experimental data, one can also determine a rate enhancement which is defined as the ratio of pressure decrease rate with enzyme to that without enzyme. Results are presented in Table 15 below.

TABLE 15

Rate enhancement
at given enzyme
concentration

| CO₂ loading | 0.1 g/L | 1.0 g/L |
|---|---|---|
| 0 | 5 | 10 |
| 0.2 | 8-10 | 13-25 |
| 0.5 | 10-12 | 12-20 |

### Some Delivery Techniques

Regarding delivery of the enzyme to the process, in one optional aspect the enzyme is provided directly as part of a formulation or solution. There may also be enzyme provided in a reactor to react with incoming solutions and gases; for instance, the enzyme may be fixed to a solid non-porous packing material, on or in a porous packing material, on or in particles or as aggregates flowing with the absorption solution within a packed tower or another type of reactor. The carbonic anhydrase may be in a free or soluble state in the formulation or immobilised on or in particles or as aggregates, chemically modified or stabilized, within the formulation. It should be noted that enzyme used in a free state may be in a pure form or may be in a mixture including impurities or additives such as other proteins, salts and other molecules coming from the enzyme production process. Immobilized enzyme free flowing in the solutions could be entrapped inside or fixed to a porous coating material that is provided around a support that is porous or non-porous. The enzymes may be immobilised directly onto the surface of a support (porous or non porous) or may be present as cross linked enzyme aggregates (CLEAs) or cross linked enzyme crystals (CLECs). CLEA include precipitated enzyme molecules forming aggregates that are then cross-linked using chemical agents. The CLEA may or may not have a ‘support’ or ‘core’ made of another material which may or may not be magnetic. CLEC include enzyme crystals and cross linking agent and may also be associated with a ‘support’ or ‘core’ made of another material. When a support is used, it may be made of polymer, ceramic, metal(s), silica, solgel, chitosan, cellulose, alginate, polyacrylamide, magnetic particles and/or other materials known in the art to be suitable for immobilization or enzyme support. When the enzymes are immobilised or provided on particles, such as micro-particles, the particles are preferably sized and provided in a particle concentration such that they are pumpable with the solution throughout the process.

When the enzymes are provided on micro-particles, the micro-particles may be sized in a number of ways. The micro-particles may be sized to facilitate separation of the micro-particles from the ion-rich mixture. For instance, the micro-particles may be sized to have a diameter above about 1 μm or above about 5 μm. The micro-particles may also be sized to have a catalytic surface area including the biocatalysts having an activity density so as to provide an activity level equivalent to a corresponding activity level of soluble biocatalysts above about 0.05 g biocatalyst/L, optionally between about 0.05 g biocatalyst/L and about 2 g biocatalyst/L. Furthermore, the absorption solution and the CO₂ form a reactive liquid film having a thickness and the micro-particles may be sized so as to be within an order of magnitude of the thickness of the reactive liquid film. The micro-particles may also be sized so as to be smaller than the thickness of the reactive liquid film. The thickness of the reactive liquid film may be about 10 μm. In another optional aspect, the micro-particles are sized between about 1 μm and about 100 μm. It should also be noted that precipitates may be formed in the ion-rich solution and the micro-particles may be sized to be larger or heavier than the precipitates or to be easily separable therefrom. In some optional aspects of the process, the particles may be sized so as to be nano-particles. The micro-particles may also be provided in the absorption solution at a maximum particle concentration of about 40% w/w. In some optional aspects, the maximum micro-particle concentration may be 35% w/w, 30% w/w, 25% w/w, 20% w/w, 15% w/w, 10% w/w, or 5% w/w. The micro-particles may be composed of support material(s) that is at least partially composed of nylon, cellulose, silica, silica gel, chitosan, polystyrene, polymethylmetacrylate, alginate, polyacrylamide, magnetic material, or a combination thereof. The support may preferably be composed of nylon or polystyrene. The density of the support material may be between about 0.6 g/ml and about 3 g/ml.

Enzymes may also be provided both fixed within the reactor (on a packing material, for example) and flowing with the formulation (as free enzymes, on particles and/or as CLEA or CLEC), and may be the same or different enzymes, including carbonic anhydrase.

In some aspects, the carbonic anhydrase enzymes may be provided as chemically modified and/or stabilized. More particularly, in one embodiment, chemically modified and stabilized carbonic anhydrase enzymes are obtained following chemical modifications of charged groups at their surface. Such modifications change the overall residual surface charge and the hydrophobicity/hydrophilicity balance of the enzymes. These modifications can be operated on an enzyme by altering polar charged groups at its surfaces and result result in significant changes in conformational stability, resistance to denaturating agents and solvents, thermostability, substrate selection, catalytic efficiency, and/or others.

It should also be noted that “carbonic anhydrase” includes analogues thereof and includes naturally occurring, modified, recombinant and/or synthetic enzymes including chemically modified enzymes, enzyme aggregates, cross-linked enzymes, enzyme particles, enzyme-polymer complexes, polypeptide fragments, enzyme-like chemicals such as small molecules mimicking the active site of carbonic anhydrase enzymes and any other functional analogue of the enzyme carbonic anhydrase.

### Thermo-Morphic Processes

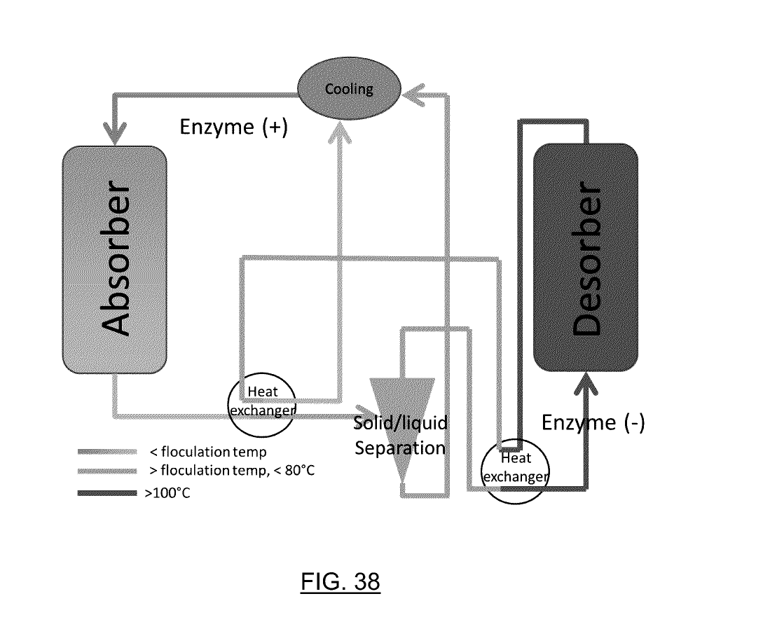

In some aspects, the carbonic anhydrase enzymes may be thermo-morphic enzymes. FIG. 38 illustrates a process according to this aspect. In one embodiment, the thermo-morphic carbonic anhydrase facilitates removal of the carbonic anhydrase prior to its passage in the regenerator or desorption unit. The thermo-morphic carbonic anhydrase may, for example, facilitate removal and thus avoid other complicated or costly separation techniques such as ultrafiltration. In this regard, there is a range of polymers that have the ability to precipitate in aqueous solution when the temperature exceeds a certain threshold. These polymers, called thermo-morphic polymers, can be covalently linked to proteins and used for selective precipitation. Poly(N-isopropylacrylamide), poly(2-ethyl-2-oxazoline) and poly(2-dimethylaminoethyl methacrylate) are polymers with thermomorphic capabilities. The precipitation temperatures of those polymers are 32° C., 62° C. and 50° C. In this aspect, at least one of such polymers is bound or linked to carbonic anhydrase to take advantage of their precipitation characteristics. Using this approach, the enzyme may be selectively recovered by thermal precipitation at the absorber exit. The precipitated enzyme may then be removed from the stream, solubilized in cold solution and returned at the top of the absorber. The enzyme-polymer catalyst can be prepared using various techniques and two different main approaches: polymer may be grafted to the enzyme or monomers may be polymerized on a functionalized enzyme. The enzyme-polymer complex is soluble in the absorption solution at the temperature used in the absorber. It accelerates CO₂ hydration in the absorber column. The temperature in the absorber should be cooler than the flocculation temperature of the thermo-morphic polymer. A higher temperature at the end of the absorber should not be a problem as long as the enzyme remains soluble for most or all of its passage through the absorber. After absorber exit, the solution is heated to a temperature high enough to dissolve the eventual contaminating solid (carbonate precipitate) and above the flocculation temperature, preferably well above the flocculation temperature (e.g. at least 10° C. above). The precipitated enzyme complexes are then removed from the stream (by centrifugation or decantation or other such separation means) and returned to the top of the absorber. Before re-entering the absorber, the enzyme containing solution will be cooled down below flocculation temperature to resolubilize the enzyme. Additional free polymer could be added to the solution to increase precipitation yield. The effect of this polymer on the solution viscosity and its CO₂ absorption capability should be evaluated. This aspect of the invention provides a way to maintain the integrity of carbonic anhydrase in a CO₂ scrubbing unit working with a high temperature desorption unit.

The following general notation has been used herein:

A_{GL} surface area of G/L interface [m²]
C_{A} concentration of A [mol·m⁻³]
D_{A} diffusion coefficient of A [m²·s⁻¹]
E_{A} enhancement factor [- [symbol]
J_{A} flux of A [mol·m²s [symbol]
k₂ second order reaction rate constant [m²·mol⁻¹s [symbol]
k₂* enzyme enhanced reaction rate constant [m³·mol [symbol] s⁻¹]
k₃* [m [symbol] ·mol [symbol] ·s⁻¹]
k₁* [m³·g¹]
k^{L} liquid side mass transfer coefficient [symbol] ·s⁻¹]
k_{OV} overall reaction rate constant [s [symbol]
m_{A} G/L distribution coefficient of A [- [symbol]
P pressure [Pa]
R gas constant [8.3] [symbol] J·mol⁻ [symbol] ·K [symbol] ]
R_{A} reaction rate of A [mol·m [symbol] s⁻¹]
T temperature [K [symbol]
V volume [m³]

The following subscripts have also been used herein:

### Am Amine

Eq equilibrium
G gas phase
inf infinite
L liquid phase
vap vapor

1.-63. (canceled)

64. A system for removing CO₂ from a CO₂-containing gas, comprising:
an absorption unit for receiving the CO₂-containing gas and an absorption solution comprising an enzyme, and for contacting the CO₂-containing gas with the absorption solution for enzymatic catalysis of the hydration reaction of CO₂ into hydrogen ions and bicarbonate ions, thereby forming a loaded absorption solution comprising enzyme, and a CO₂-depleted gas;
a unit for receiving the loaded absorption solution comprising the enzyme and inducing precipitation, thereby forming a stream including precipitates that include enzymes;
a separation unit for receiving the stream including precipitates that include enzymes, and producing an enzyme-depleted stream and an enzyme-containing stream;
a regenerator for receiving the enzyme-depleted stream to produce a CO₂ stream and a regenerated solution stream; and
a unit for combining the regenerated solution stream and enzyme-containing stream to form the absorption solution comprising the enzyme.

65. The system of claim 64, wherein the unit for inducing precipitation includes a heater for enabling thermal precipitation of the enzyme to produce precipitated enzyme complexes.

66. The system of claim 65, wherein the enzymes comprise thermo-morphic polymers.

67. The system of claim 66, wherein the thermo-morphic polymers are covalently linked to the enzyme.

68. The system of claim 67, wherein the thermo-morphic polymers include poly(N-isopropylacrylamide), poly(2-ethyl-2-oxazoline) and/or poly(2-dimethylaminoethyl methacrylate).

69. The system of claim 66, wherein the thermo-morphic polymer is grafted to the enzyme, or monomers of the thermo-morphic polymer are polymerized on a functionalized enzyme.

70. The system of claim 66, wherein the heater is configured to heat the loaded absorption solution at least 10° C. above a flocculation temperature of the thermo-morphic polymer.

71. The system of claim 65, wherein the heater is configured to heat the loaded absorption solution to at least a precipitation temperature.

72. The system of claim 64, further comprising a cooling unit for receiving the enzyme-containing stream and cooling sufficiently to solubilize the enzyme.

73. The system of claim 72, wherein the cooling unit is also configured to receive the regenerated solution stream.

74. The system of claim 64, wherein the separation unit is configured to induce separation by centrifugation or decantation.

75. A process of absorbing CO₂ from a CO₂-containing gas, comprising:
contacting an absorption solution comprising an enzyme or analog thereof with the CO₂-containing gas, for enzymatic catalysis and absorbing the CO₂ from the CO₂-containing gas and producing a CO₂-depleted gas and a loaded absorption solution comprising enzyme;
inducing precipitation in the loaded absorption solution, thereby forming a stream including precipitates that include enzymes;
separating the stream including precipitates that include enzymes, to produce an enzyme-depleted stream and an enzyme-containing stream;
regenerating the enzyme-depleted stream to produce a CO₂ stream and a regenerated solution stream; and
combining the regenerated solution stream and enzyme-containing stream to form the absorption solution comprising the enzyme.

76. The process of claim 75, wherein the step of inducing precipitation includes heating to enable thermal precipitation of the enzyme to produce precipitated enzyme complexes.

77. The process of claim 76, wherein the enzymes comprise thermo-morphic polymers.

78. The process of claim 77, wherein the thermo-morphic polymers are covalently linked to the enzyme.

79. The process of claim 78, wherein the thermo-morphic polymers include poly(N-isopropylacrylamide), poly(2-ethyl-2-oxazoline) and/or poly(2-dimethylaminoethyl methacrylate).

80. The process of claim 77, wherein the thermo-morphic polymers are grafted to the enzyme, or monomers of the thermo-morphic polymers are polymerized on a functionalized enzyme.

81. The process of claim 77, wherein the heater is configured to heat the loaded absorption solution at least 10° C. above a flocculation temperature of the thermo-morphic polymer.

82. The process of claim 76, wherein the heating step is performed so as to heat the loaded absorption solution to at least a precipitation temperature.

83. The process of claim 75, further comprising cooling the enzyme-containing stream to solubilize the enzyme.

84. The process of claim 83, wherein the cooling step is also performed on the regenerated solution stream.

85. The process of claim 75, wherein the separation step includes centrifugation or decantation.

86. The process of claim 77, further comprising adding additional free thermo-morphic polymers to increase precipitation yield.

87. A method for increasing or maximizing a capture rate of CO₂ from a CO₂-containing gas into an absorption solution, the method comprising:
selecting an enzyme or analog thereof for enzymatic catalysis of the hydration reaction of CO₂ into hydrogen ions and bicarbonate ions within the absorption solution; and
selecting the absorption solution having a pKa such that the absorption solution combined with the selected enzyme or analog thereof enhances kinetics of the enzymatic catalysis of the hydration reaction of CO₂.

88. The method of claim 87, wherein the step of selecting the absorption solution is performed such that the pKa maximize the capture rate of CO₂ in presence of the selected enzyme or analog thereof.

89. The method of claim 88, further comprising providing a concentration of the selected enzyme or analog thereof in the absorption solution in accordance with the pKa thereof.

90. The method of claim 87, wherein the step of selecting the absorption solution is performed in accordance with the following formula:
$${k}_{2}^{*} = \frac{{k}_{3}^{*} {C}_{Enzyme}}{1 + {k}_{4}^{*} {C}_{Enzyme}}$$
k₂* being a reaction rate constant of the CO₂ capture rate;
C_{Enzyme} being the concentration of the at least one enzyme; and
k₃* and k₄* being first and second reaction rate constants associated with the enzyme, wherein:
k₃*=A+B pKa;
k₄*=C+D pKa;
A, B, C and D are coefficients related to the enzyme; and
pKa is the logarithmic acid dissociation constant associated with the absorption solution.

91. The method of claim 90, wherein the step of coordinating comprises selecting the enzyme so as to increase or maximize k₃* and reduce or minimize k₄* at the pKa of the absorption solution.
